(19) United States
(12) Patent Application Publication
(10) Pub. No.: US 2016/0011731 A1
(43) Pub. Date: Jan. 14, 2016

(54) System and Method for Revealing Content on an Electronic Device Display

(71) Applicant: BlackBerry Limited, Waterloo (CA)

(72) Inventors: Jerome PASQUERO, Montreal (CA); Jason Tyler GRIFFIN, Kitchener (CA); Lauren Avril PALMER, Kitchener (CA); Justine Sun DELA CRUZ, Montreal (CA)

(21) Appl. No.: 14/329,542

(22) Filed: Jul. 11, 2014

(51) Int. Cl. G06F 3/0484; G06F 3/0481

(52) U.S. Cl. CPC G06F 3/0484; G06F 3/0481

(57) ABSTRACT

A system and method are provided for concealing content displayed on electronic devices. The method includes concealing content of a first application user interface and displaying a reveal window on a portion of the first application user interface, the reveal window providing a view of a portion of the content of the first application user interface. The method also includes enabling the reveal window to be moved to provide additional views of portions of the content of the first application user interface.

### TECHNICAL FIELD

The following relates to systems and methods for revealing content on an electronic device display.

### DESCRIPTION OF THE RELATED ART

Electronic devices such as smart phones, tablet and laptop computers and other handheld devices are increasingly used for many day to day tasks and provide multitasking, messaging, and other computing capabilities. When multitasking, a user is often required to navigate out of and into various applications, which can be time consuming and disruptive when numerous communications are received during such multitasking.

With an increase in usage of portable electronic devices, there is also an increase in the amount of potentially confidential or sensitive information from being seen by others, particularly when the devices are used in public.

### BRIEF DESCRIPTION OF THE DRAWINGS

FIG. 1 illustrates example mobile devices;

FIG. 2 is a block diagram illustrating an example of a configuration for a mobile device having a content revealer;

FIG. 3 illustrates a mobile device revealing content beneath an obscured user interface being displayed by the mobile device;

FIG. 4 is a flow chart illustrating computer executable instructions for using a content revealer on a mobile device;

FIG. 5 is a flow chart illustrating computer executable instructions for obstructing and further revealing content using a content revealer on a mobile device;

FIG. 6 is a flow chart illustrating computer executable instructions for executing a stealth mode of operation using a content revealer on a mobile device;

FIG. 7 is an example of a mobile device in a standby mode;

FIG. 8 is an example of a mobile device displaying a dimmed messaging application user interface;

FIG. 9 is an example of a mobile device displaying a dimmed messaging application during a scrolling interaction with the capacitive keyboard;

FIG. 10 is an example of a mobile device displaying a dimmed messaging application during a reply operation;

FIG. 11 is an example of a mobile device displaying a dimmed message conversation user interface during a typing operation;

FIG. 12 is an example of a message hub user interface;

FIG. 13 is an example of a mobile device displaying a dimmed message hub user interface;

FIG. 14 is an example of a mobile device displaying a dimmed message hub user interface with a reveal window;

FIG. 15 is an example of a mobile device displaying a dimmed message hub user interface during movement of a reveal window;

FIG. 16 is an example of a mobile device displaying a message user interface;

FIG. 17 is an example of a mobile device displaying text obfuscation of a message user interface;

FIG. 18 is an example of a mobile device displaying text obfuscation to a message user interface with a reveal window;

FIG. 19 is an example of a mobile device displaying text obfuscation to a message user interface during movement of a reveal window;

FIG. 20 is an example of a mobile device displaying an application user interface;

FIG. 21 is an example of a mobile device displaying a reveal window through an application user interface;

FIG. 22 is an example of a mobile device displaying a reveal window through an application user interface during movement of the reveal window;

FIG. 23 is an example of a mobile device displaying a reveal window through an application user interface during an interaction with a message;

FIG. 24 is an example of a mobile device displaying a reveal window through an application user interface during a typing operation;

FIG. 25 is an example of a mobile device displaying an application user interface;

FIG. 26 is an example of a mobile device illustrating initiation of a reveal window;

FIG. 27 is an example of a mobile device displaying a reveal window through an application user interface;

FIG. 28 is an example of a mobile device displaying a reveal window through an application user interface during an interaction with the user interface;

FIG. 29 is an example of a mobile device displaying a reveal window through an application user interface during a reply operation;

FIG. 30 is an example of a mobile device displaying a reveal window through an application user interface during a typing operation;

FIG. 31 is an example of a personal computer displaying an application user interface;

FIG. 32 is an example of a personal computer displaying a reveal window through an application user interface;

FIG. 33 is an example of a personal computer displaying a reveal window through an application user interface during movement of the reveal window;

FIG. 34 is an example of an electronic viewing device with a receiver and a pointing device containing a tracking area;

FIG. 35 is an example of an electronic viewing device with a receiver and a pointing device containing a tracking area where a reveal window is launched on the electronic viewing device;

FIG. 36 is an example of an electronic viewing device with a receiver and a point device containing a tracking area where the input detected on the pointing device changes the position of a reveal window;

FIG. 37 is a flow chart illustrating computer executable operations performed by a mobile device in a standby mode;

FIG. 38 is a flow chart illustrating computer executable operations performed by a mobile device for revealing content in a messaging environment;

FIG. 39 is a flow chart illustrating computer executable operations performed by a mobile device for revealing content beneath a media player user interface;

FIG. 40 is a flow chart illustrating computer executable operations performed by a mobile device for revealing content during a scrolling operation;

FIG. 41 is an example of a capacitive keyboard device with a display screen and a keyboard;

FIG. 42 is an example of a capacitive keyboard device displaying a reveal window;

FIG. 43 is an example of a capacitive keyboard device displaying a reveal window during movement of the reveal window;

FIG. 44 is an example of a capacitive keyboard device displaying a reveal window during movement of the reveal window;

FIG. 45 is an example of a settings user interface for a content revealer; and

FIG. 46 is an example of a configuration for a mobile electronic communication device.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

With electronic devices, keyboards may be used for textual inputs and to activate functions within the device. The operation of input devices, for example keyboards, may depend on the type of electronic device and the applications used by the device.

Examples of applicable electronic devices include pagers, cellular phones, cellular smart-phones, wireless organizers, personal digital assistants, personal computers, laptops, handheld wireless communication devices, wirelessly enabled tablet computers, handheld gaming devices, in-vehicle navigation or infotainment systems, cameras and the like. Such devices will hereinafter be commonly referred to as “mobile devices” for the sake of clarity. It will however be appreciated that the principles described herein are also suitable to other devices, e.g. “non-mobile” devices.

It has been found that providing an ability to reveal at least some content of one application that underlies another application or has been at least partially obscured or darkened on a display screen enables both multitasking and security concerns to be addressed. For example, a messaging application can be revealed beneath a currently viewed application to enable brief glimpses of the messaging application without having to navigate away from the currently viewed application. Similarly, discreet glimpses of content of an application while otherwise concealing screen content (e.g., in a standby mode) enables some functionality of a device to be utilized with minimal distractions to other users, e.g., within a meeting or public setting.

In one aspect, there is provided a method of operating an electronic device, the method comprising: concealing content of a first application user interface; displaying a reveal window on a portion of the first application user interface, the reveal window providing a view of a portion of the content of the first application user interface; and enabling the reveal window to be moved to provide additional views of portions of the content of the first application user interface.

In another aspect, there is provided an electronic device comprising a processor, a display, at least one input device, and memory, the memory comprising computer executable instructions for: concealing content of a first application user interface; displaying a reveal window on a portion of the first application user interface, the reveal window providing a view of a portion of the content of the first application user interface; and enabling the reveal window to be moved to provide additional views of portions of the content of the first application user interface.

In yet another aspect, there is provided a non-transitory computer readable medium comprising computer executable instructions for operating an electronic device, the computer executable instructions comprising instructions for: concealing content of a first application user interface; displaying a reveal window on a portion of the first application user interface, the reveal window providing a view of a portion of the content of the first application user interface; and enabling the reveal window to be moved to provide additional views of portions of the content of the first application user interface.

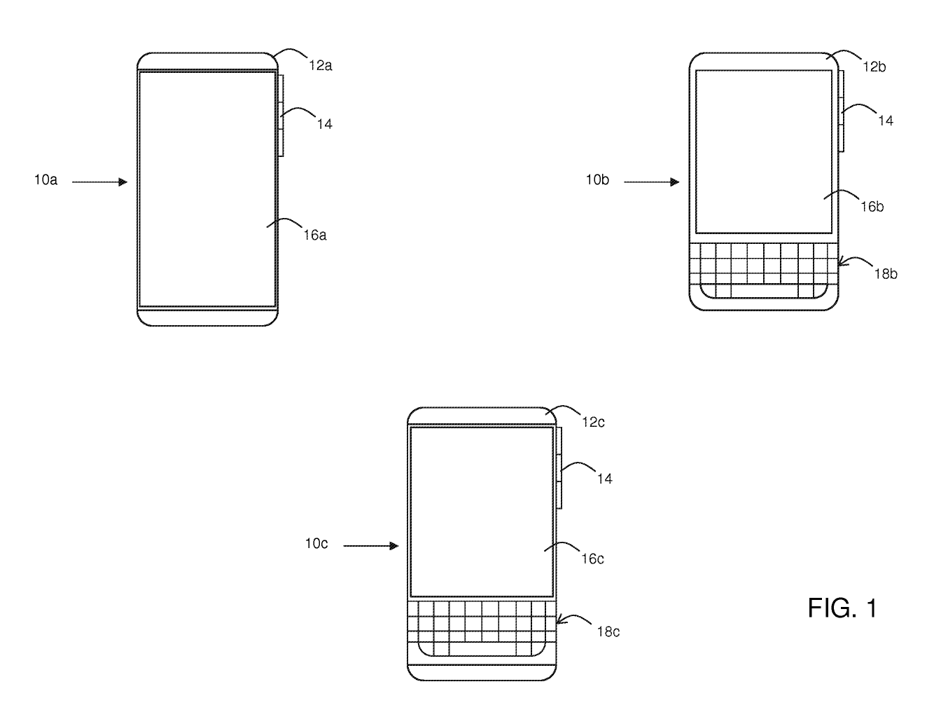

Turning now to FIG. 1, three different examples of mobile devices 10 are shown. It can be appreciated that the mobile devices 10 shown in FIG. 1 are shown as such for illustrative purposes and various other configurations and form factors can be used. A first mobile device 10a shown in FIG. 1 employs a “full” touch screen, (hereinafter referred to as a “full touch device 10a”). The full touch device 10a includes a housing 12a and a set of buttons 14 located on the side of the housing 12a, which are operable to perform particular functions. It can be appreciated that the buttons 14 can be physical buttons, capacitive buttons or can utilize any other suitable technology for providing an input mechanism to the full touch device 10a. The full touch device 10a includes a display screen 16a that encompasses the majority of the front facing surface area of the housing 12a. The display screen 16a can include a resistive touch screen panel, a capacitive touch screen panel, or any other technology for implementing a touch sensitive screen. Additionally, the display screen 16a can be any one of known technologies, including liquid-color display (LCD), light-emitting diode (LED) display, organic light-emitting diode (OLED) display, active-matrix organic light-emitting diode (AMOLED) display, or any variants or equivalents thereof.

A second mobile device 10b shown in FIG. 1 employs a physical keyboard (hereinafter referred to as a “physical keyboard device 10b”). The physical keyboard device 10a includes a housing 12b, a display screen 16b, and a set of buttons 14 located on the side of the housing 12b, similar to the full touch device 10a. The display screen 16b can also include touch screen functionality to detect inputs. The physical keyboard 18a in this example is a typical QWERTY keyboard. It can be appreciated that additional keys can be included to facilitate the input of non-alpha characters, for example commas, periods and numerals.

A third mobile device 10c shown in FIG. 1 employs a capacitive keyboard (hereinafter referred to as a “capacitive keyboard device 10c”). The capacitive keyboard device 10c includes a housing 12c, a display screen 16c, and a set of buttons 14, similar to the full screen and physical keyboard devices 10a and 10b respectively. The display screen 16c can also include touch screen functionality to detect inputs. The capacitive keyboard 18c is a physical, QWERTY keyboard with capacitive input capabilities that facilitates user interactions and increases the usability of an area previously dedicated to alphanumeric input. Such interactions can include, for example, swiping movements, mimicking the use of a track pad/touchpad and, more generally, as another method of input for an electronic device. As such, the capacitive keyboard 18c provides both touch and tactile functionality to serve as both keyboard and alternative input areas.

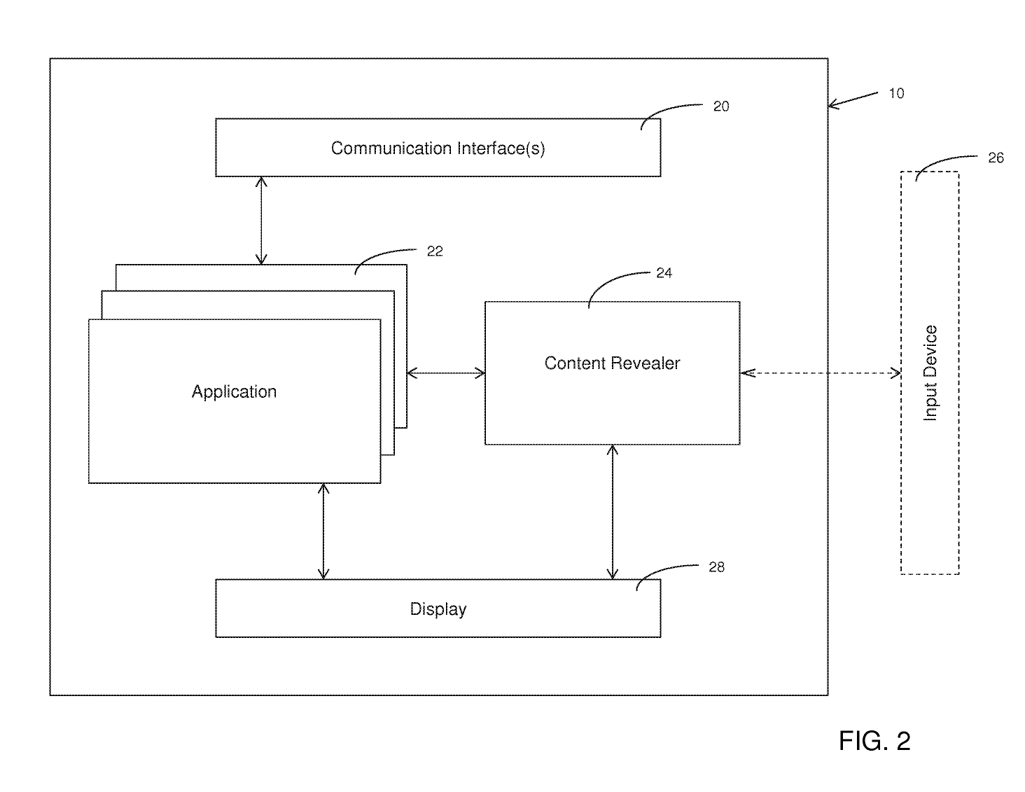

An example of a configuration for a mobile device 10 is shown in FIG. 2. The mobile device 10 includes one or more communication interfaces 20 to enable the mobile device 10 to communicate with other devices, services, entities, and domains. The one or more communication interfaces 20 in this example generally represents any one or more short-range, wide-area, wired, or wireless communication connections utilizing a connection/connector/port, wireless radio, etc. The mobile device 10 also includes a display component 28, which may be used by various applications and services on the mobile device 10 including one or more applications 22 in the example shown in FIG. 2. The applications 22 can include, for example, communication applications (e.g. instant messaging (IM)), social media, games, multimedia (e.g. video player, picture viewer, etc.), default or “native” applications that are preinstalled on the device, or other downloadable applications.

Also shown in FIG. 2 is an input device 26 which can be external to the mobile device 10 as shown by way of dashed lines, or can be integral with the mobile device 10. The input device 26 can also be part of or otherwise provided by other components of the mobile device 10. For example, the display component 28 can provide touch capabilities for receiving inputs.

A content revealer 24 is utilized by the mobile device 10 to reveal content displayed by a user interface that is beneath or otherwise concealed by an overlying user interface or darkened or obscured portions of the user interface itself. For example, with multiple applications running on the mobile device 10 a currently used application is typically displayed while other active running applications are concealed or “covered” by the currently used application. In another example, the current application can be darkened or dimmed except for a portion that is revealed to provide a screen lock or standby mode with the ability to glimpse at least a portion of the application user interface that is being obscured or darkened. The content revealer 24 enables at least a portion of the content of an underlying or obscured application 22 to be revealed using a window through the overlying application or created by not darkening or obscuring a portion of the application. It can be appreciated that the “reveal window” can also extend through a plurality of application user interface layers, e.g., to display content in an application user interface that is beneath two or more application user interfaces. In another example, the reveal window can be used to reveal content beneath a layer of obfuscation or concealment (e.g. a black screen hiding content being displayed by the mobile device 10) or by selectively darkened or obscuring all but the content within the reveal window. As such, the content revealer 24 can be executed to provide a reveal window through any overlying layer being displayed by the mobile device 10 or by selectively not applying concealment or darkening to a particular portion of an application being displayed. The content revealer 24 can also communicate with the underlying or otherwise revealed application 22 to enable interactions with the underlying application 22 while the reveal window is being used, e.g., to view and respond to messages, etc.

Content revealer 24 may also operate by revealing the content of an underlying layer even though at least one overlying layer is obstructing the content. For example, a user can be browsing messages in a messaging application before opening a games application. Since the games application was opened after the messaging application, the games application resides on the overlying layer of the mobile device's screen and is the currently visible application. Content revealer 24 can facilitate the viewing of messages in the messaging application even with the games application occupying the front layer of the device's screen. In another example, a user can first be browsing messages in a messages application before opening a games application and subsequently further opening a multimedia application to watch a video. The multimedia application resides on the visible overlying layer of the mobile device's screen, with the games application occupying the immediate underlying layer the messages application occupying the bottom-underlying layer. As discussed above, the content revealer 24 can facilitate the viewing of messages in the messages application even with two applications occupying overlying layers. As such, content revealer 24 can operate with any number of layers with the applications in any order.

In one example various default settings or preferences can be used. For example, the content revealer 24 can be instructed to have a messaging application be the default application when the content revealer 24 is active. In such an example, when the content revealer 24 is executed, the underlying layer that is revealed through the reveal window would be the messaging application. It can be appreciated that any application 22 can be set as a default application and various criteria can be employed to selectively determine which underlying application should be revealed. Moreover, such default settings need not be specified.

As discussed, content revealer 24 can be utilized to reveal any number of layers where the number of layers can be preset. For example, if the number of reveal layers is set to one, then only the most recent underlying layer is revealed; if the number of reveal layers is set to four, then the fourth most recent underlying layer is revealed; etc.

The content revealer 24 operates in conjunction with applications 22 after receiving a predetermined input from an input device 26. It can be appreciated that the input device 26 can be included as part of the mobile device 10 or may exist as a separate component. An input device 26 can include, for example, a button 14 on the housing 12, a key press from a keyboard 18, a button selectable from a graphical user interface (GUI) displayed on the display screen 16, a visual or auditory command, or through any other independent component that can be connected to the mobile device 10.

It can be appreciated that the mobile device 10 as shown in FIG. 2 can be adapted in a similar configuration for any electronic device. The mobile device 10 can be implemented on any electronic device that includes a communication interface 20, an application 22 to view content, an input device 26 and a display component 28 or other viewing screen capable of displaying content. As illustrated below, in addition to mobile devices 10, an electronic device which may employ the principles herein can include, for example, televisions. The communication interface 20 can connect a television to a network. An application 26 can include the different audiovisual (AV) input ports of a television whereby each AV port is a unique application, and a display 28 can include the television screen. A remote control or any other input device 26 can launch the content revealer 24.

FIG. 3 illustrates a mobile device 10 utilizing a reveal window 38 to reveal content 36 of an application. In one example, the mobile device 10 is operating with a visible top layer 34 and an underlying bottom layer 36 while the content revealer 24 is active. It can be appreciated that in such an example, the top layer 34 can be any first layer that is situated on top of at least a second layer. The top layer 34 can include a dimmed layer or mask that obscures the display screen 16 until the screen is nearly or completely dark (hereinafter referred to as a “stealth mode”). The top layer 34 can also be a text obfuscation layer on the display screen 16 that renders content illegible (hereinafter referred to as “text obfuscation”). The top layer 34 can also be a first application window that obstructs the view of the desired second application window (hereinafter referred to as a “peek mode”). To provide the reveal window 38 in such an example, the portion of the top layer 34 that provides the reveal window 38 can include a higher transparency (or lower opacity) to therefore allow the content 36 to be revealed.

In another example, the mobile device 10 can operate on a single layer 34 that selectively darkens or brightens individual pixels to obscure most of a user interface while revealing a number of pixels that correspond to the area designated as the reveal window 38. For example, an OLED display 16 can be utilized to provide such selective darkening to individual pixels that are currently not part of the reveal window 38. In the following examples, it can be appreciated that principles discussed concerning a top layer 34 or other overlying layer can equally apply to a single layer being selectively darkened (e.g. to glimpse content in a standby or security mode).

Content underneath or part of the top layer 34 can be viewed when an appropriate input is detected by a mobile device 10. In FIG. 3, a touch input 32 initiates the display of a reveal window 38 by the content revealer 24. It can be appreciated that other inputs can be used to initiate the reveal window 38 including visual, auditory, or tactile inputs other than those applied to a touch sensitive display 16. It can also be appreciated that the reveal window 38 can be of any size or shape and the example shown in FIG. 3 is only illustrative. For example, the reveal window 38 can be small and oval shaped or a large square. It can also be appreciated that the reveal window 38 can have any level of illumination (e.g. 0 to 100% brightness) and be of any color (e.g. yellow, green, red).

The content 36 displayed through the reveal window 38 allows the user to view and/or interact with such content. In one example, the content 36 can be related to a message hub or messaging application user interface. In other examples, other application types provide the content 36, e.g., based on being the most recent active window. For example, if a user is browsing an application, the top layer 34 may be the active application and the underlying layer providing the content 36 can be a previously opened application. In the example shown in FIG. 3, as a touch input 32 moves over a tracking area 40, the reveal window 38 correspondingly moves and the content 36 being revealed changes. It can be appreciated that in at least one example, the top layer 34 effectively blocks the bottom layer 36 and prevents others from viewing the contents of the bottom layer 36. The contents of the bottom layer 36 become visible when a predetermined input is detected by the mobile device 10.

The reveal window 38 can be permitted to move about the entirety of the display screen 16 or can be restricted to particular tracking areas. Also, movements of the reveal window 38 can be restricted or unrestricted. For example, full “analog” control over the movements of the reveal window 38 can be provided. In another example, the reveal window 38 can be moved discretely and/or automatically, e.g. to move directly to or “jump” between fields or to automatically move over predetermined portions of the content 36 being revealed such as a subject line of a message, etc. As such, the reveal window 38 can employ predetermined behaviors and/or logic to control the manner in which the reveal window 38 is moved, which may vary based on the application being revealed, the mode being operated, etc.

The tracking area 40 can be any area of the mobile device 10 where input can be detected. For example, if the mobile device 10 is a capacitive keyboard device 10b, the tracking area 40 can be located on the capacitive keyboard 18c. In such an example, sliding a touch input 32 over the keys of the capacitive keyboard 18c can move the focus of the reveal window 38. Alphanumeric keys can continue to be entered by selecting keys on the capacitive keyboard 18c. In another example, if the mobile device 10 is a full touch device 10a, the tracking area 40 can be located at a predetermined designated portion of the display screen 16a. The tracking area 40 can exist in conjunction with the full touch device keyboard 18b. Therefore the keyboard 18b can function as both the keyboard of the mobile device 10 and as the tracking device 40. Sliding the touch input 32 can correspond to a scrolling operation applied to the reveal window 38, whereby the tracking area 40 detects the corresponding inputs. Alphanumeric keys can continue to be entered by selecting the keys on the touch screen keyboard. In yet another example, if the mobile device 10 is a physical keyboard device 10b with a touch enabled display screen 16b, the tracking area 40 can be a portion of the display screen 16b. The keyboard 18b can continue to be used for textual input. While these examples utilize touch or manual inputs to move the reveal window 38, it can be appreciated that other tracking-type inputs can be used such as an eye tracking input that determines the user's point of gaze and follows the point of gaze to move the reveal window 38. In this way, potentially distracting interactions with a mobile device 10 can be further minimized.

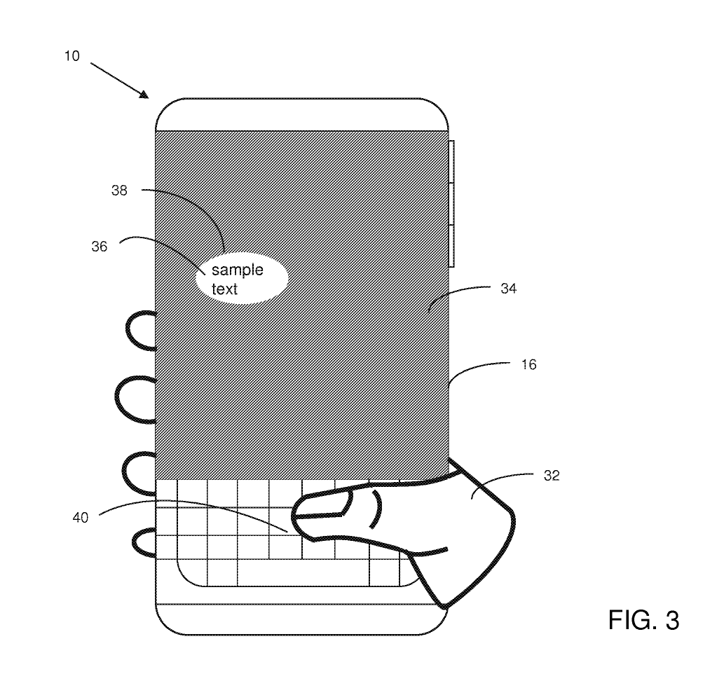

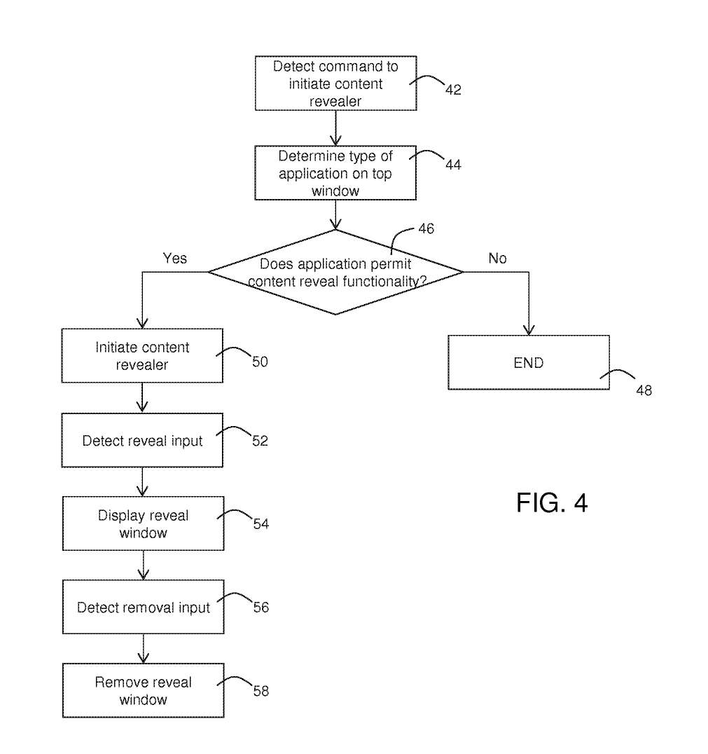

FIG. 4 illustrates computer executable operations performed by an electronic device 10 in utilizing the content revealer 24. At 42 a command or input is detected for initiating the content revealer 24, and the content revealer 24 determines at 44 whether or not the application 22 that is currently being displayed permits content to be revealed within or through its user interface. For example, certain applications 22 can be configured to not permit the content revealer 24 to operate while that application 22 is the currently viewed application 22 or while that application 22 is being obscured in a standby or security mode. If the application does not permit content 36 to be revealed at 46, the process ends at 48. If the application 22 permits content to be revealed, the content revealer 24 is initiated at 50. A reveal input is detected at 52 and a reveal window 38 is displayed at 54 to reveal a localized area within or under the currently viewed user interface. As discussed above, the reveal window 38 can be dynamic to move with a corresponding input. A further input detected at 56, such as removal of a touch input 32 to the tracking area 40, causes the reveal window 38 to be removed at 58. It can be appreciated that content revealer 24 can still be active after the removal of input and the removal of the reveal window 38 such that subsequent inputs can be detected to turn on and turn off the reveal window 24, as discussed below.

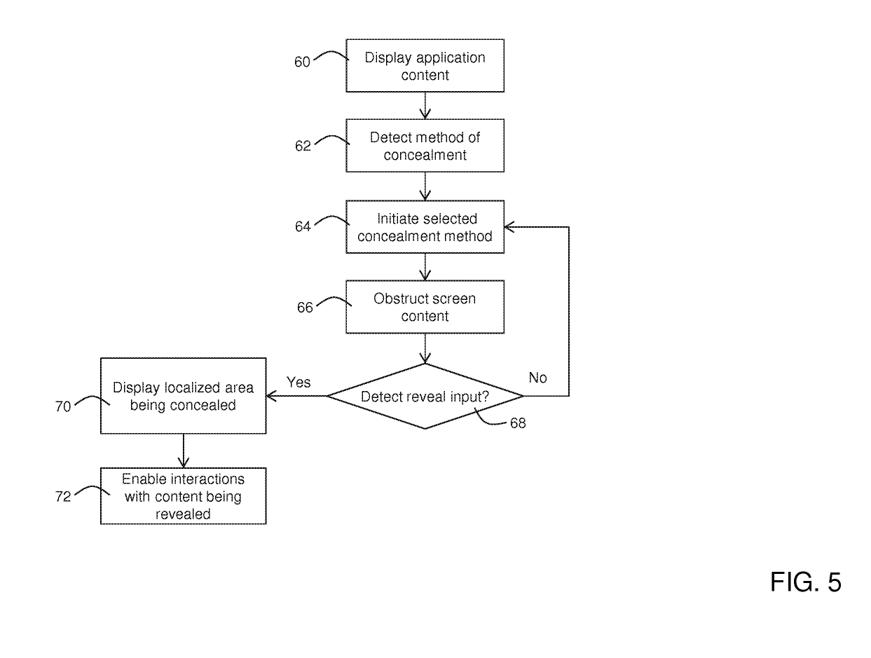

In FIG. 5 computer executable instructions are shown that can be executed when the mobile device 10 is on and content is displayed on the top window at 60 but a method of concealment of the content is detected at 62. For example, the mobile device 10 can be in a standby mode wherein the content is concealed by applying a masking layer or by darkening pixels of the application user interface. In this example, the “standby mode” may refer to a lower power mode of the electronic devices where the device screen is off or otherwise darkened. Such modes can also be referred to as sleep mode or hibernation and will hereinafter be commonly referred to “standby mode” for the sake of clarity. The activation of content revealer 24 is detected by the device through an input (e.g. selecting a button 14, holding down a key on the keyboard 18 or selection from the GUI, etc.). In this example, the selected concealment method is initiated at 64 to obstruct content currently being displayed at 66. The content revealer 24 is also active during the concealment and determines at 68 whether or not an input to reveal content is detected. It can be appreciated that reveal input can include the selection of a button 14, input detected on the display screen 16, the selection of a key on the keyboard 18, etc. If such an input is not detected, the process returns to 64 and the selected method of concealment continues to obstruct the screen content. If a reveal input is detected at 68, a reveal window 38 is initiated to display localized content at 70, e.g., by increasing transparency of a portion of an overlying application 22, by selectively brightening pixels of an application 22 which has darkened pixels in the remaining portion, etc. With the reveal window 38 being displayed, the particular content 36 on the screen is exposed to the user to enable interactions therewith at 72.

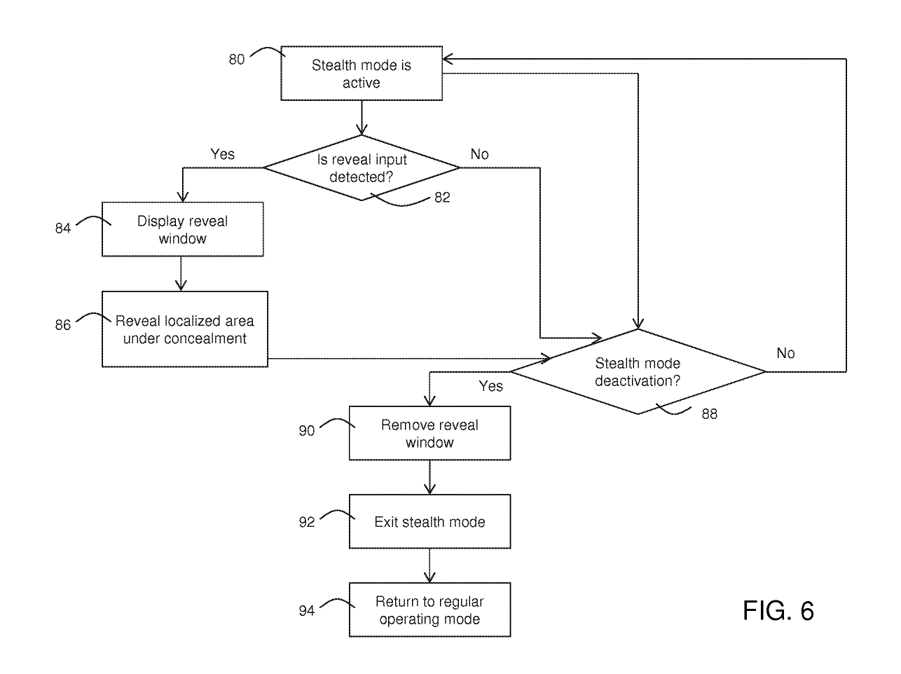

FIG. 6 illustrates computer executable operations performed by an electronic device to execute a “stealth mode” of operation wherein the reveal window 38 is used to enable discreet interactions with a user interface to allow the device to be used while minimizing distractions caused by such use. At 80, the content revealer 24 is initiated for use during a stealth mode. At 82, the content revealer 24 determines if a reveal input is detected. If so, the reveal window 38 is displayed at 84 to enable the user to view and interact with content 36 at 86, while still being in stealth mode. For example, during a meeting, a user may observe an incoming flash notification and interact with the device to reveal content in the stealth mode to briefly determine the sender of the corresponding communication. If a reveal input is not detected at 82, it is determined at 88 whether or not a deactivation input is detected. For example, the stealth mode may be configured to remove the reveal window when a touch input no longer exists (e.g., user lifts finger from display 16). If not deactivated, the process may repeat to enable the stealth mode to be utilized, e.g., in conjunction with a method of concealment to allow interactions with minimal distractions. If a deactivation input is detected at 88, the reveal window is removed at 90 and the stealth mode is exited at 92. The device may then return to a regular mode of operation at 94.

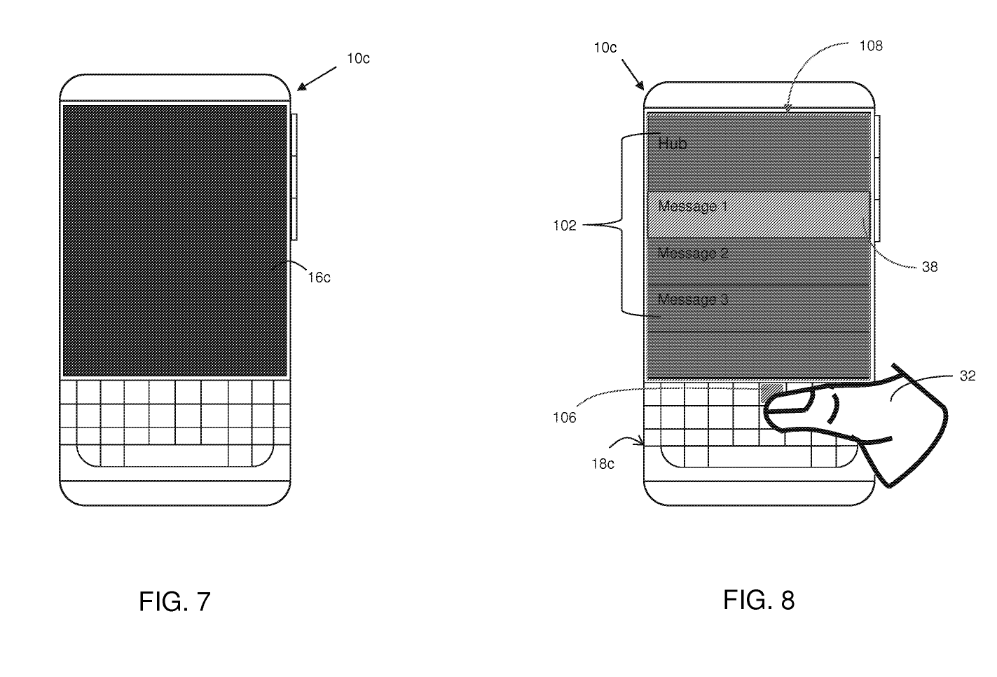

FIG. 7 illustrates a stealth mode of operation, where a dimming layer or mask is used to conceal a current application user interface or the current application is darkened by darkening the pixels of the screen 16.

Turning to FIG. 8, a touch input 32 is detected in this example, which selects a key 106 on the capacitive keyboard 18c to initiate a reveal mode such as a stealth mode to permit interactions with the capacitive keyboard device 10c in a discreet manner. The key 106 can be a predetermined key. It can be appreciated that any method of input can be selected to awaken the capacitive keyboard device 10c, and the key 106 is used by way of example only. The capacitive keyboard device 10c is on and a dimming layer 108 is applied to the display screen 16c. The dimming layer 108 can be a masking layer that includes at least some transparency, selectively controlling the brightness of the pixels of the display screen 16, or any other equivalent method for at least partially obscuring the content of the application 22 being displayed. For example, the dimming can facilitate using the mobile device 10 in a dark environment, where an otherwise bright light would be distracting to others or pose security or confidentiality issues with the displayed content.

In FIG. 8, a message hub displaying a series of messages 102 is revealed beneath the dimming layer 108. It can be appreciated that the message hub and messages 102 may be the most recently or currently displayed application 22 or may be a default or predetermined application permitted to be revealed during the reveal or stealth mode of operation. In this example, a reveal window 38 is shown and positioned over the first message of the series of messages 102. The reveal window 38 provides a relatively brighter area of focus on the display screen 16c and facilitates navigation throughout the application. For example, a dimming layer 108 applied over an application 22 can selectively increase the transparency of the dimming layer 108 in the area of the message to thereby create the reveal window 38 shown in FIG. 8. In another example, pixels of the application user interface itself can be controlled to provide more dim and less dim areas as shown in FIG. 8.

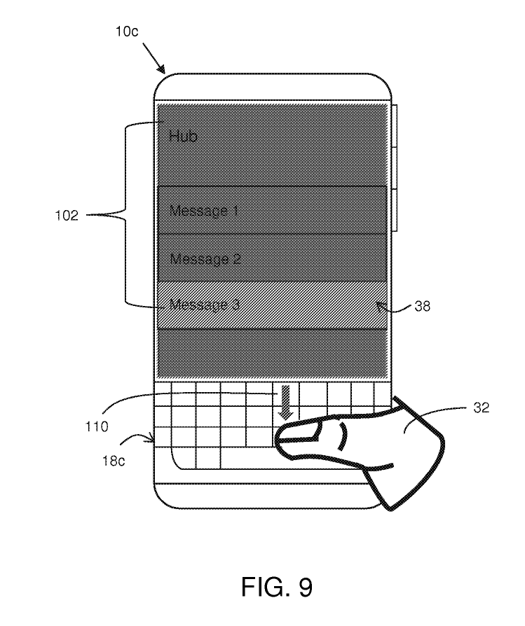

As shown in FIG. 9, a touch input 32 moving along the capacitive keyboard 18c in the direction of the arrow 110 causes a scrolling operation to be applied to the reveal window 38. The input is detected by the capacitive keyboard device 10c and the reveal window 38 correspondingly moves downwards such that the reveal window 38 appears over the last message of the series of messages 102 in this example.

It can be appreciated that the reveal window 38 can move in any direction and anywhere along the two-dimensional display screen 16 according to a corresponding input 32.

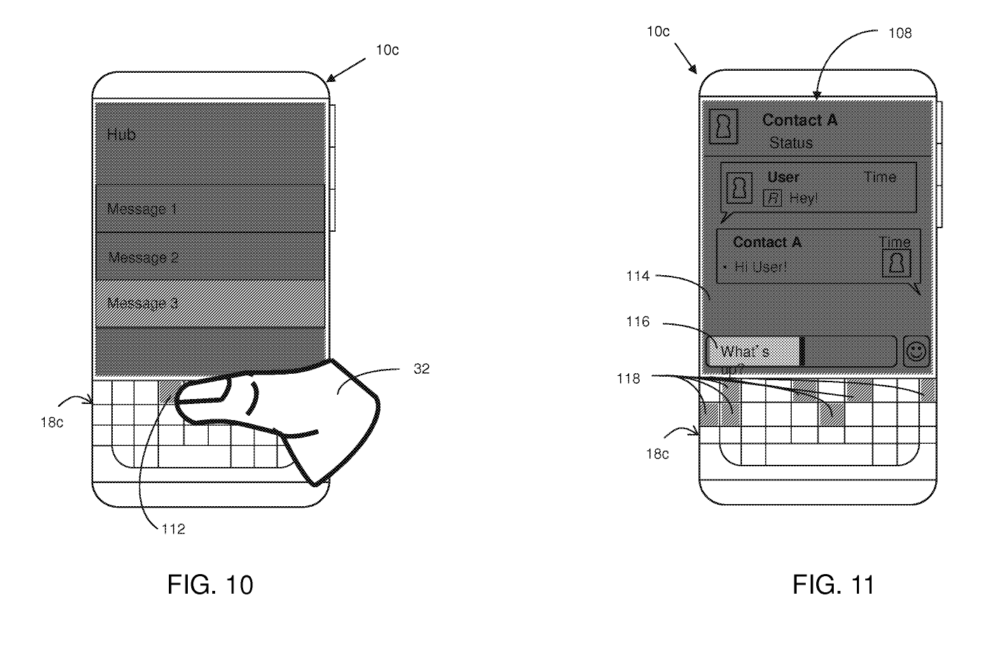

Turning now to FIG. 10, the touch input 32 continues with the selection of a key 112 on the capacitive keyboard 18c. The selected key 112 can open the message, as shown in FIG. 11. The selected key 112 can be any key (e.g. the ‘R’ key corresponding to a “reply” function) and can be held for any number of seconds or selected in combination with a known pattern before the message opens.

A corresponding conversation 114 associated with the selected message is shown in FIG. 11. The dimming layer 108 continues to reside on the top layer of the display screen 16c. The reveal window 38 in this example is moved or otherwise transformed into a text input window 116 with the inputted text being highlighted compared to the remainder of content under the dimming layer 106. The text input window 116 facilitates the viewing of text. The selected keys 118 in FIG. 11 correspond to the text of the text input highlight window 116.

Though not shown, the removal of input to the mobile device 10 can cause the device to return to a standby mode or other operating mode. The lack of input, whether from the keyboard 18, the display screen 16 or a button 14, for a predetermined number of seconds can stop stealth mode and the display screen 16 of the mobile device 10 can turn off or revert to a standby or security mode, as shown in FIG. 7.

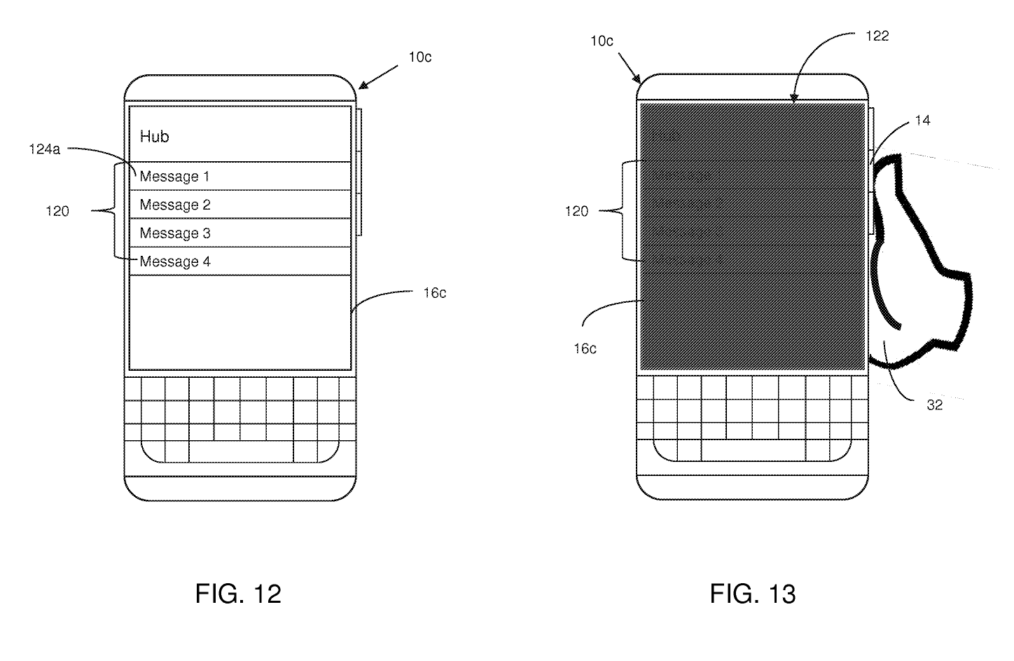

In another example of the stealth mode, the capacitive keyboard device 10c is turned on and a messaging application is opened. In FIG. 12 a series of messages 120, including the message 124, are displayed on the display screen 16c. As shown in FIG. 13, a touch input 32 selecting a button 14 is detected, which initiates the stealth mode. It can be appreciated that any method of input can be selected to initiate stealth mode, and the button 14 is used by way of example. A dimming layer 122 is situated on the top layer of the display screen. It can be seen that the content on the display screen 16c is obstructed in this example.

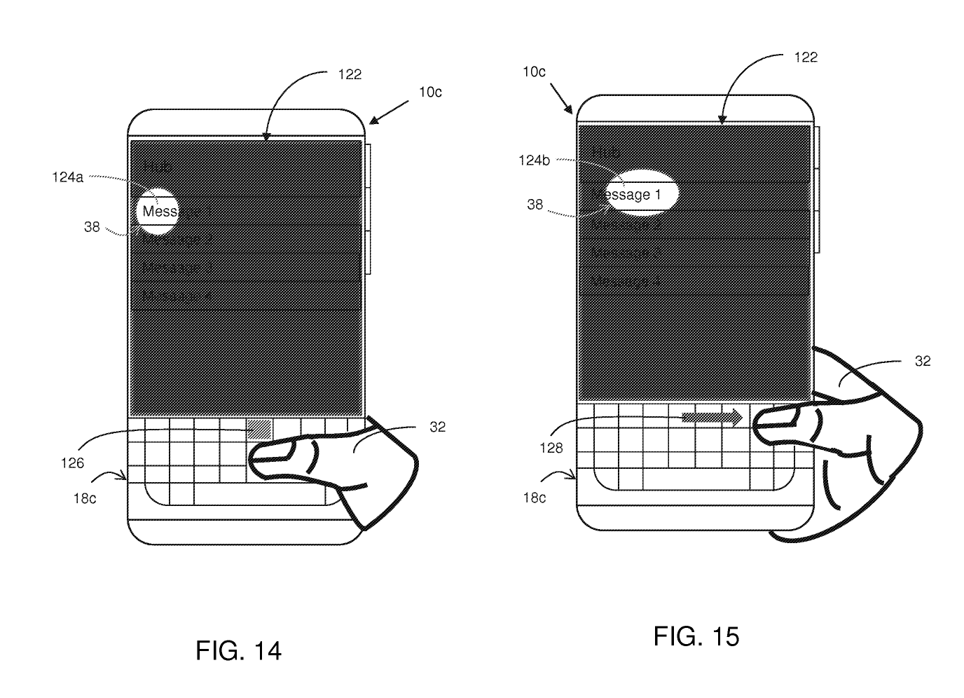

In FIG. 14, a touch input 32 selects a key 126 on the capacitive keyboard 18c to initiate the reveal mode, wherein a reveal window 38 appears and content 124a can be viewed in or through the reveal window 38. The reveal window 38 facilitates the viewing of a portion of the display screen 16c such that the dimming layer 122 does not affect a localized area of the screen.

Turning to FIG. 15, the touch input 32 moves in a rightward direction along the capacitive keyboard 18c in the direction of the arrow 128. The input is detected by the capacitive keyboard device 10c and the reveal window 38 correspondingly moves. It can be seen that the content 124b on the screen has also changed to reveal new content that is viewed through the reveal window 38 as it moves. In one example, the size of the reveal window 38 is dynamic and as such, the reveal window 38 can expand from a circle in FIG. 14 to an oval in FIG. 15. In another example, the reveal window 38 can expand to a certain size before it moves in its entirety. In yet another example, the reveal window 38 is of a fixed size and moves in a manner that corresponds to the input detected by the mobile device 10.

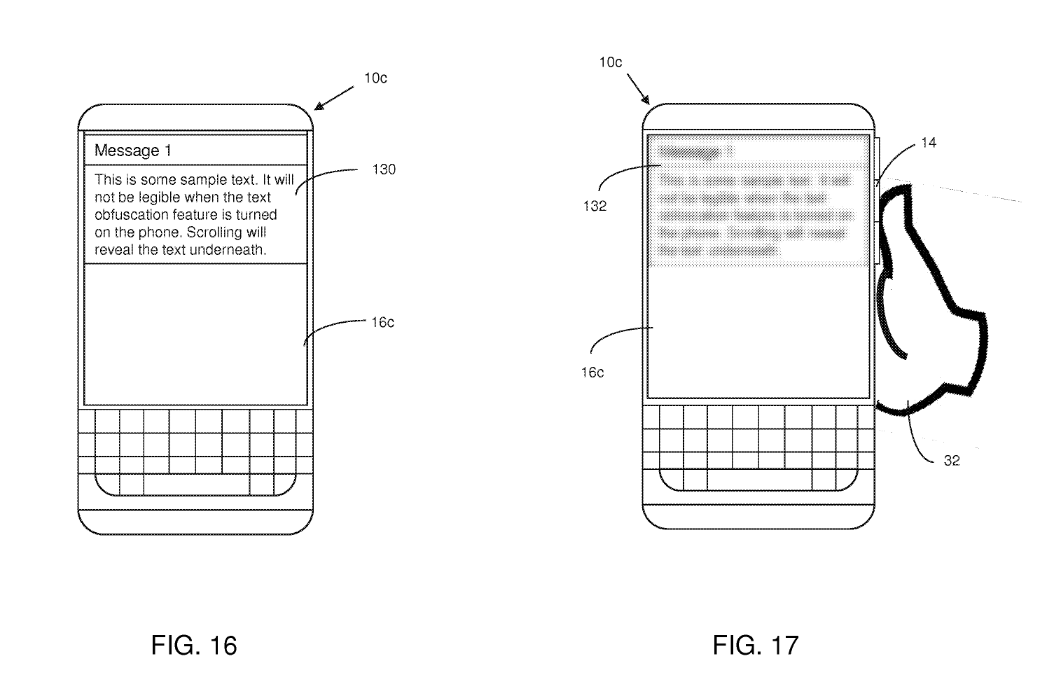

FIG. 16 illustrates another example applied to the capacitive keyboard device 10c, where a message 130 is open on a display screen 16c. In FIG. 17, a touch input 32 selecting a button 14 is detected, which initiates text obfuscation of the message 130. It can be appreciated that any method of input can be selected to initiate the stealth mode, and the button 14 is used by way of example. An obfuscation layer 132 is situated on the top layer of the display screen 16c. It can be seen that the content on the display screen 16c is obstructed. As with the dimming layer 108 described above, the obfuscation layer 132 can also be provided by individually controlling a blurriness of pixels of an application, i.e. the obfuscation layer 132 can also be a modification of the application user interface itself.

The text obfuscation layer 132 can be of any size and can occupy any area of the display screen 16c. In FIG. 17, the obfuscation layer 132 occupies the contents of the message 130. However, the text obfuscation layer can be dynamic and grow or decrease in size. In one example, as the user is inputting text and the message 130 is increasing in length, the obfuscation layer also grows. The obfuscation layer 132 can expand and continue to encompass the contents of the message. In another example, the obfuscation layer occupies the entire screen without increasing or decreasing in size.

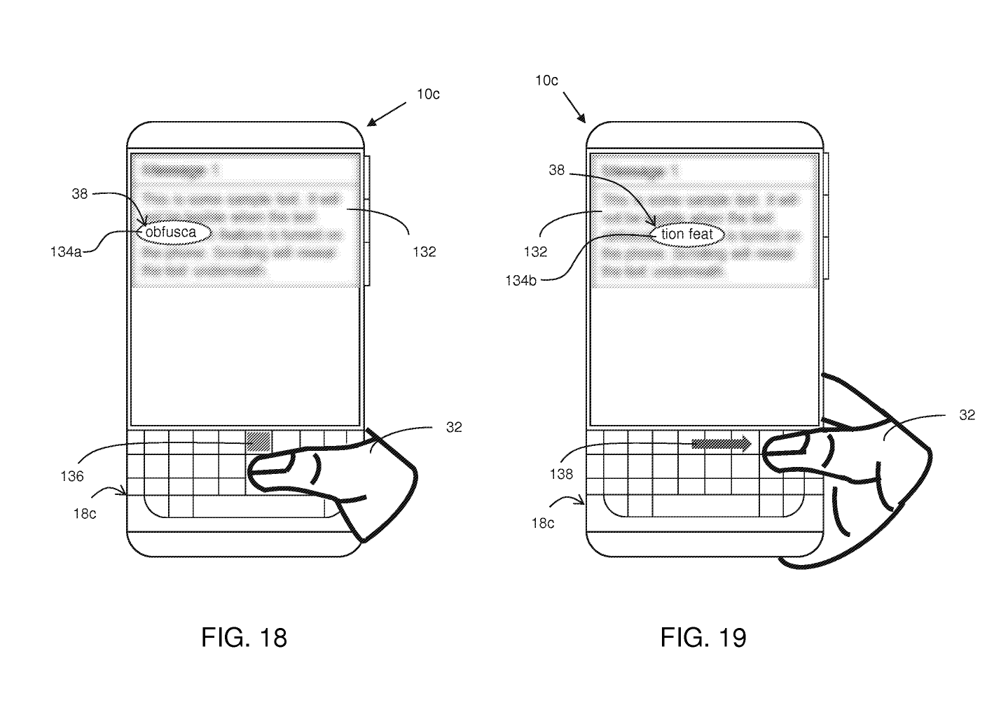

In FIG. 18, a touch input 32 selecting a key 136 on the capacitive keyboard 18c is detected, which initiates use of the reveal window 38 to reveal content 134a through the reveal window 38. The reveal window 38 facilitates the viewing of a portion of the display screen 16c such that the obfuscation layer 132 does not affect a localized area of the screen.

Turning to FIG. 19, the touch input 32 moves in a rightward direction along the capacitive keyboard 18c in the direction of the arrow 138. The input is detected by the capacitive keyboard device 10c and the reveal window 38 correspondingly moves. It can be seen that the content 134b on the screen has also changed to reveal what is currently underneath or within the reveal window 38.

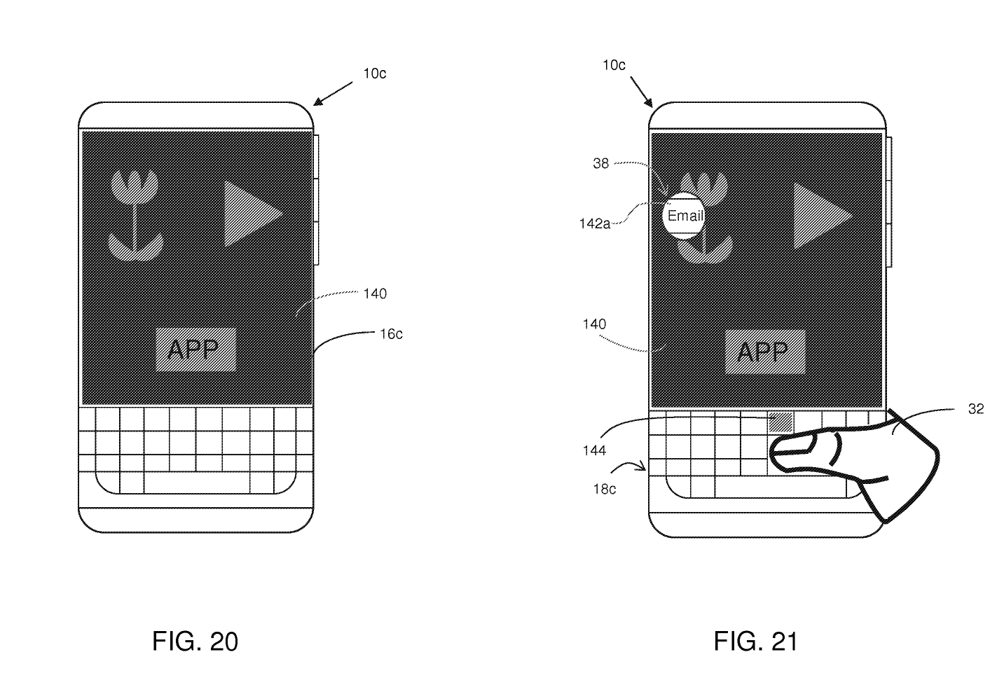

FIG. 20 is another example for revealing content beneath a currently displayed application user interface 140. It can be appreciated that the application 22 can be a multimedia application (such as a picture viewer or video player), a games application, a social media application, a browser, an app, etc.

In FIG. 21, a touch input 32 selecting a key 144 is detected by the capacitive keyboard 18c to initiate a peek mode. It can be appreciated that any method of input can be selected to initiate peek mode, and the key 144 is used by way of example. The method of input can be detected in many ways, for example, the key 144 can be a predetermined key, the key 144 can be selected in a pattern that is predetermined, a plurality of keys on the capacitive keyboard 18c can be selected, etc. As shown in FIG. 21, the reveal window 38 can be initiated to reveal content 142a of the underlying application. The reveal window 38 facilitates viewing a portion of the display screen 16c such that a localized area under the screen is visible through the application 140. In this way, a user can conveniently view particular portions of an underlying application, e.g., to see who the sender of a message is, without having to navigate away from the application 140 currently being viewed.

It can be appreciated that the peek mode can operate without interrupting an application 140. For example, a video application is open where a user is watching a video. After the mobile device detects input, peek mode can reveal an area under the screen while the video is playing. The video continues uninterrupted and the reveal window can move corresponding to the detected input.

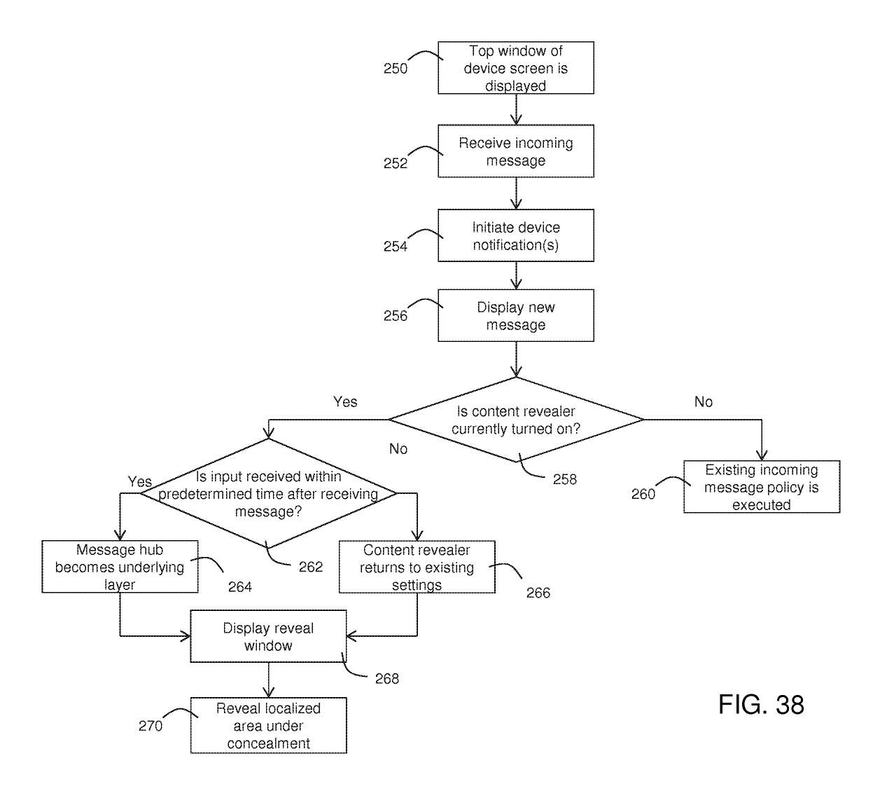

In one example, the peek mode shown in FIG. 21 can be initiated by default when a new message is received. The capacitive keyboard 18c can detect user input for a predetermined amount of time after a message is received, whereby the input can cause the reveal window 38 to appear. The reveal window can disappear whenever input is no longer detected. FIG. 38, described below, illustrates the initiation of the peek mode following the receipt of a new message.

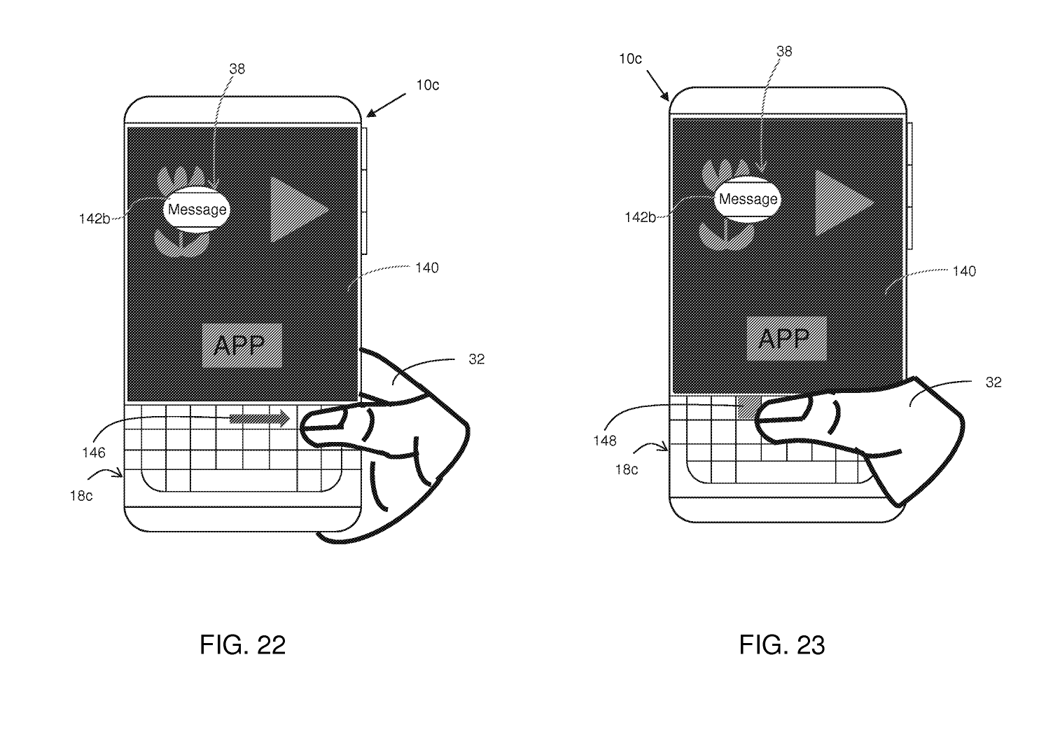

Turning to FIG. 22, as the touch input 32 moves in a rightward direction along the capacitive keyboard 18c in the direction of the arrow 146, the reveal window 38 also moves. In this example, the application 140 continues to display content in an uninterrupted fashion despite use of the reveal window 38.

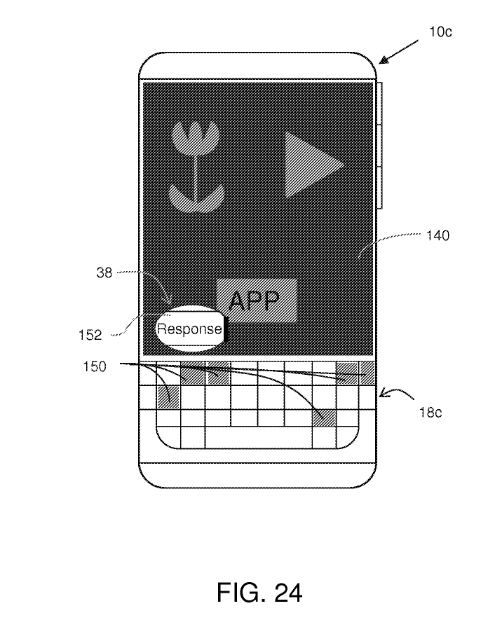

In FIG. 23, the touch input 32 selects a key 148 on the capacitive keyboard 18c. The selection of the key 148 changes the content of the display screen 16c and permits a reply message to be composed, as shown in FIG. 24. The selected key 112 can be any key (e.g. the ‘R’ key) and can be held for any number of seconds or selected in combination with a known pattern before the message opens.

Upon detecting selection of the key 112 for replying to the message, the reveal window 38 moves to the response field 152 and facilitates the user to view the text inputted for the response without requiring the touch input 32 to move the reveal window 38. The text response field 152 is consistent with the properties associated with the reveal window 38 (e.g. is illuminated to the same brightness, can be dynamic or static in size, moves in accordance with the inputted text, does not interrupt the application 140, and etc.). The selected keys 150 in FIG. 24 correspond to the text of the text response field 152.

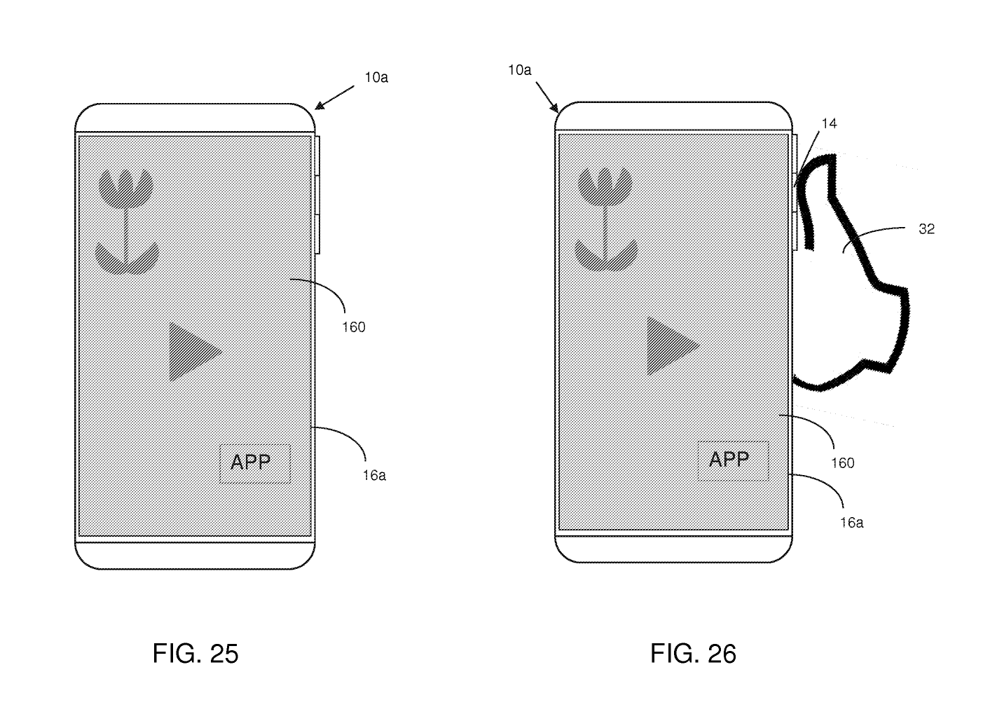

FIG. 25 illustrates another example of a peek mode for a full touch device 10a displaying an application 160. In FIG. 26, a touch input 32 selecting the button 14 to initiate the peek mode is detected. It can be appreciated that any method of input can be selected to initiate peek mode, and the button 14 is used by way of example.

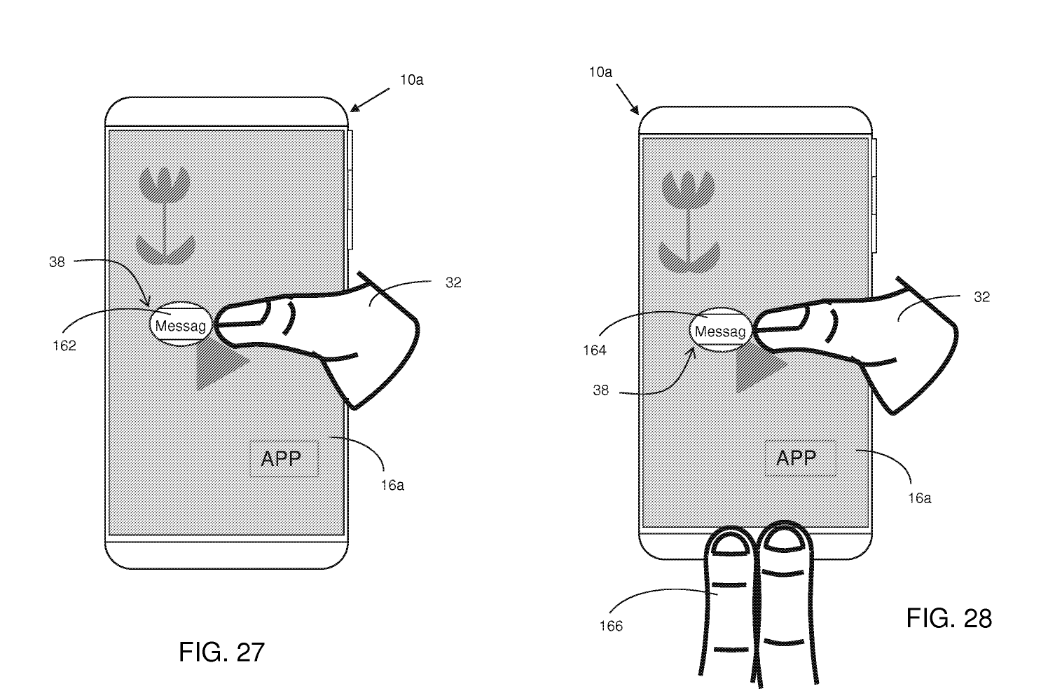

Following initiation of the peek mode, if input is detected by the display screen 16a within a predetermined number of seconds, the reveal window 38 appears and content of the underlying application can be viewed as shown in FIG. 27. In FIG. 27, the touch input 32 corresponds to where the reveal window 38 is displayed and thus to where underlying content 162 can be viewed. It can be appreciated that any movement of the touch input 32 detected by the display screen 16a can cause the reveal window 38 to correspondingly move. Similar to FIG. 21, it can be appreciated that peek mode can operate without interrupting the application 160. Moreover, the peek mode can be initiated by default when a new message is received or according to the detection of some other event. As such, the button 14 would not be required to initiate the peek mode.

In FIG. 28, a two finger swipe gesture 166 is detected on the display screen 16a to initiate the peek mode. In one example, the gesture 166 can be detected within a predetermined amount of time from another input, including the touch gesture 32. If no input is detected, peek mode can be turned off. In yet another example, inputs from both the touch input 32 and the gesture 166 can be detected simultaneously to initiate the peek mode.

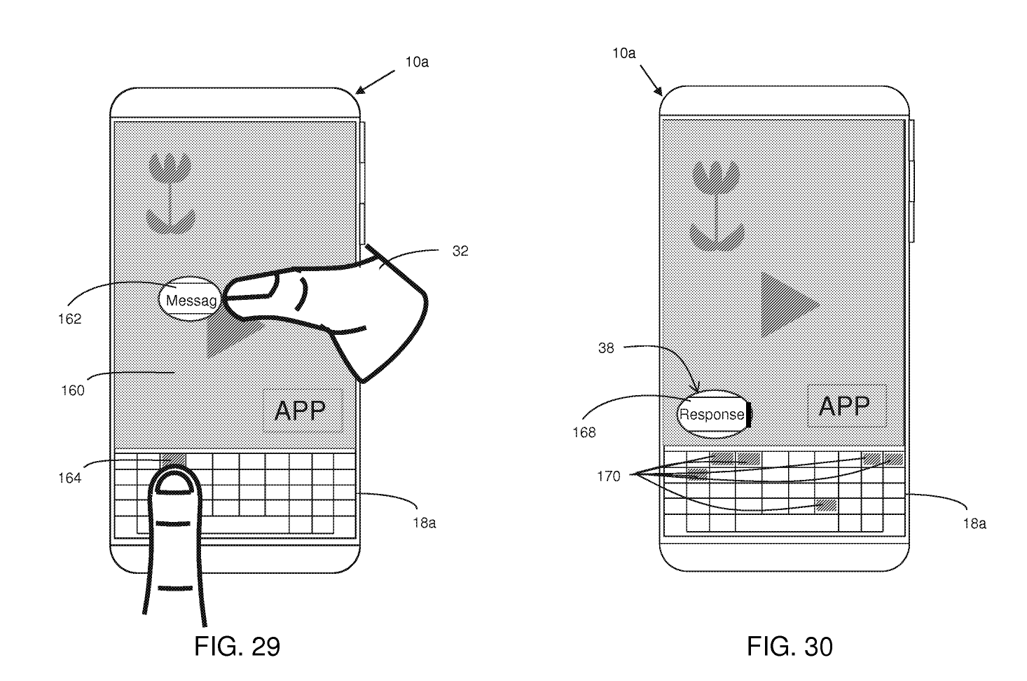

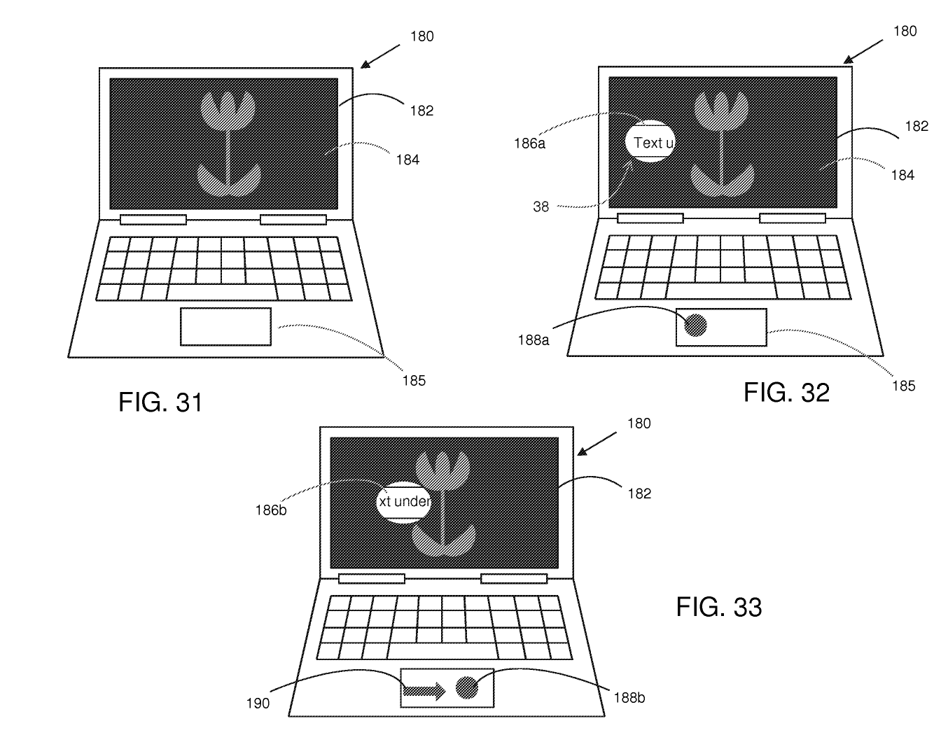

Turning to FIG. 29, the gesture 166 can initiate a tracking area 164 to appear. The tracking area 164 can exist in conjunction with a keyboard displayed on the full touch device 10a, or can be any area dedicated to receiving input. The tracking area 164 can shrink the useable area of the application 160 on the display screen 16a. It can be appreciated that the application 160 can scale according to the new useable area. In another example, the tracking area can include the entire display screen 16a. As such, the input detected by the display screen corresponds to the location of the reveal window 38. In FIG. 29, a button 164 is selected. The selection of the button 164 can permit a reply to a message to be typed, as shown in FIG. 30. The selected button 164 can be a key on the keyboard, or can be an area of the tracking area 164 that is held for any number of seconds or selected in combination with a known pattern.

Upon the selection to reply to the message, a response field 168 appears and facilitates a user to view the text inputted for the response. The text response field 168 is consistent with the properties associated with the reveal window 38 (e.g. is illuminated to the same brightness, can be dynamic or static in size, moves in accordance with the inputted text, does not interrupt the application 140, and etc.). The selected keys 170 in FIG. 30 correspond to the text of the text response field 168. As such, it can be appreciated that the interactions with the mobile device 10 applicable to capacitive keyboard devices 10c equally apply to those using virtual keyboards.

As discussed above, the principles discussed herein with respect to mobile devices 10 can be applied to any electronic device.

FIG. 31 is an example of an application of the peek mode to a computer 180 such as a tablet, laptop or other “personal computer”. In the example shown in FIG. 31, a computer screen 182 is currently displaying an application 184 which occupies an upper visible layer of the computer screen 182 and any number of underlying layers can be present. Turning to FIG. 32, peek mode is initiated and an input 188a is detected on a track pad 185. The input 188a launches the reveal window 38 where underlying content 186a can be viewed. It can be appreciated that the input 188a can be any input and is not limited to the track pad 185. For example, the input can be a key press, a button dedicated to initiating content revealer 24, or a combination of inputs detected on the track pad 185. In FIG. 32, the application 184 continues to operate uninterrupted by the peek mode.

As shown in FIG. 33, the input 188b moves in the direction of the arrow 190, and a further input 188b is detected thereby moving the reveal window 38.

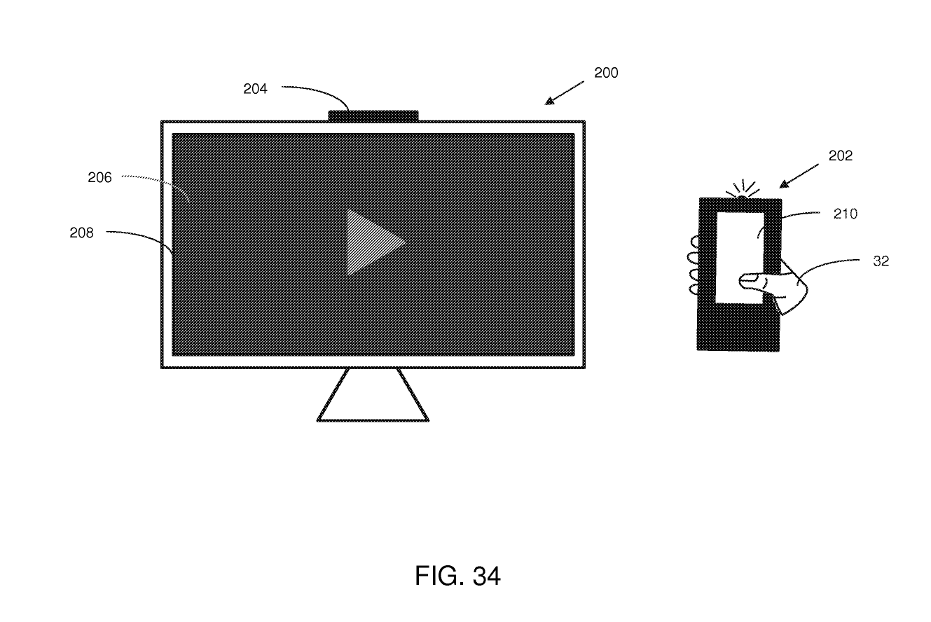

FIG. 34 illustrates another example of an application of the peek mode to an electronic device 200 that can interact with a pointing device 202. The electronic viewing device 200 (e.g. a television, projector screen or a monitor) is displaying content 206 on its display screen 208. The content 206 can be a video, an application or a picture and occupies the top layer of the display screen 208. A separate pointing device 202 can serve as input to the electronic viewing device 200. The pointing device 202 in FIG. 34 contains a tracking area 210, e.g., which includes a capacitive touch interface.

The pointing device 202 can include, for example, a remote control, a mobile device 10, or other sensor or equipment. A receiver 204 detects input from the pointing device 202. The receiver 204 can communicate in one of many methods, e.g., Bluetooth, infrared, etc. In yet another example, the receiver 204 and the pointing device 202 can be connected through a wired connection. The pointing device 202 and the receiver 204 can also be integrated into one unit. For example, the receiver can have embedded sensors (e.g. infrared sensors, cameras, motion detecting sensors) that can capture input from an object in its field of view.

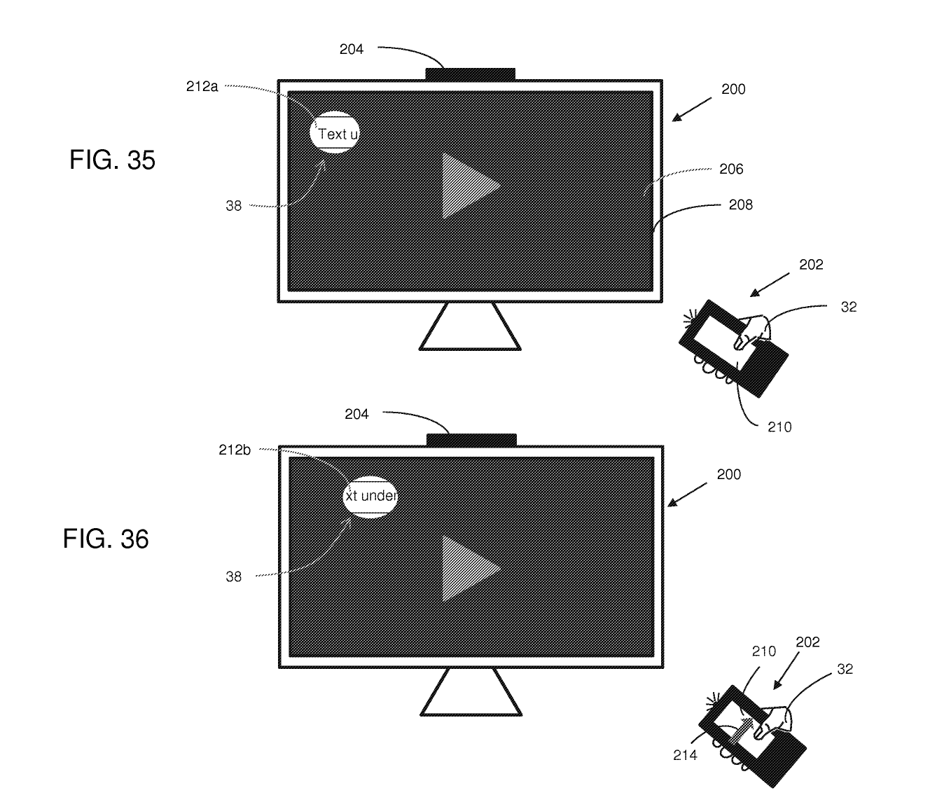

In FIG. 35, the tracking area 210 of the pointing device 202 detects inputs from a touch input 32. The information is transmitted from the pointing device 202 and received by the receiver 204. The reveal window 38 can appear on the display screen 208 where underlying content 212a can be viewed. The underlying content 212 can correspond to a previously opened application whose window layer is below the currently open application 206.

Turning to FIG. 36, the tracking area 210 of the pointing device 202 detects that the touch input 32 has moved to the right in the direction of the arrow 214. The information is transmitted from the pointing device 202 and received by the receiver 204. The reveal window 38 correspondingly moves to the right and new underlying content 212b can be viewed.

FIGS. 34 to 36 illustrate that the content revealer 24 can be used in various types of electronic devices. In previous examples, a single electronic device was illustrated. However, it can be seen that a second, third, fourth or any other number of electronic devices can operate in conjunction to execute the content revealer functionality. Furthermore, it can also be seen that content revealer is not limited to an electronic device that receives input directly from a user. In FIGS. 34 to 36, the pointing device 202 and the receiver 204 act as intermediaries between the user and the electronic viewing device 200. The tracking area 210 of the pointing device 202 can first detect the input before it is transmitted to the receiver 204 and finally displayed on the display screen 208.

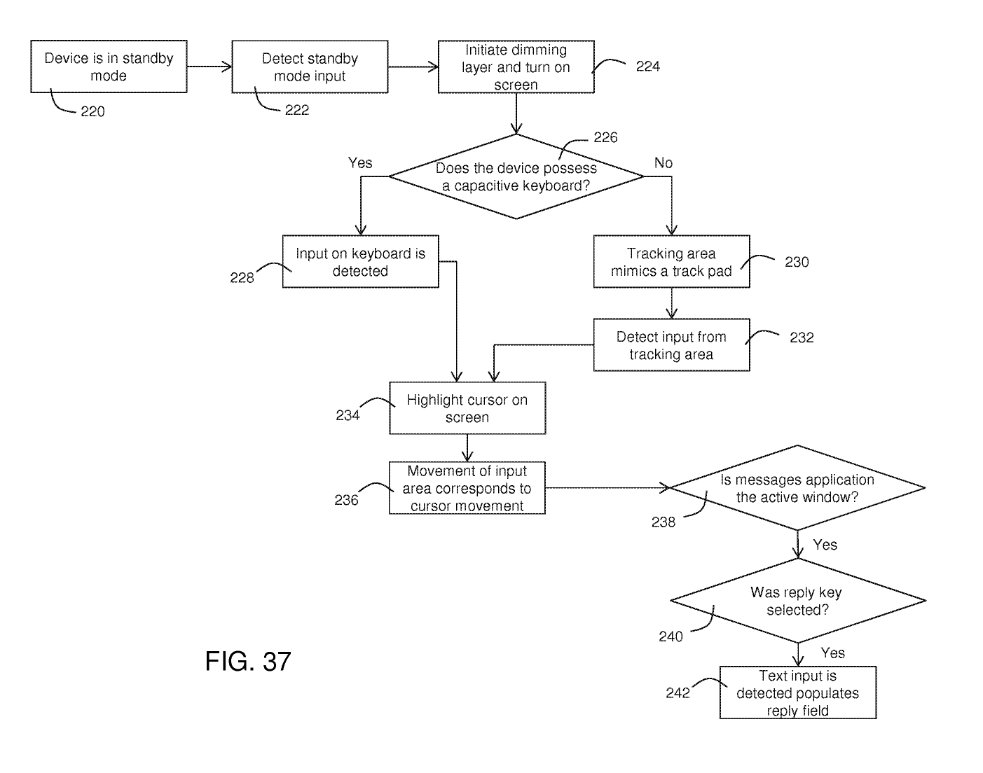

FIG. 37 illustrates computer executable operations performed by the electronic device to initiate a standby mode and exemplifies using the reveal window 38 to reply to a message in a messaging application. At 220 the device is in standby mode, with the display screen off and a low-power state is executed. An input to initiate standby mode is detected by the device at 222. By way of example, the input can be the selection of a button, holding down a key on a keyboard, or the device can start in a standby mode or otherwise be automatically transitioned into the standby mode according to predetermined criteria. At 224, the display screen is turned on but a dimming layer is displayed on display screen. The dimming layer obstructs the view of the content on the screen. A check to determine if the electronic device possesses a capacitive keyboard is made at 226. If the capacitive keyboard is not detected, then at 230 a tracking area is used to mimic a track pad. The tracking area can include a trackball, an area on the screen, or any other area that facilitates input of multi-directional movement. Input from the tracking area is detected at 232.

If the device possesses a capacitive keyboard, then input on the keyboard is detected at 228. From both 232 and 228, the detected input launches the highlighted reveal window 38 on the screen at 234. Any input that is detected from the tracking area corresponds to the movement of the reveal window at 236. For example, swiping downwards on the tracking area moves the reveal window downward as well. A check is made at 238 to determine if the active window is a messages application. If yes, then a second check is made at 240 to determine if a reply key was selected. If yes, text input is detected and the reply field is populated at 242.

FIG. 38 illustrates computer executable operations performed by the electronic device when a new message is received. At 250, the device is on and a window is occupying the top layer on the device's screen. A message is received at 252 and device notifications are initiated at 254. Device notifications can include, for example, vibration, alert of an audio signal, a visual notification such as a blinking light or any combinations thereof. At 256, the new message is displayed, e.g., wherein it is pushed to the top of a messages list. However, it can be appreciated that the message and other messages can be positioned in any order. A check to determine if content revealer is turned on is made a 258. If content revealer is not turned on, then the existing incoming message policy is executed, i.e., the content revealing functionality is not utilized. If the content revealer 24 is active, a check to determine if input is detected within a predetermined amount of time upon receiving the message is made at 262. If yes, then the message hub becomes the immediate underlying layer at 264. If input was not detected before the predetermined amount of time, then the device continues with its existing settings (i.e. the messages hub is not the immediate underlying layer) at 266. For both 264 and 266, since an input was detected, a reveal window appears at 268 and the reveal window reveals a localized area previously under concealment at 270.

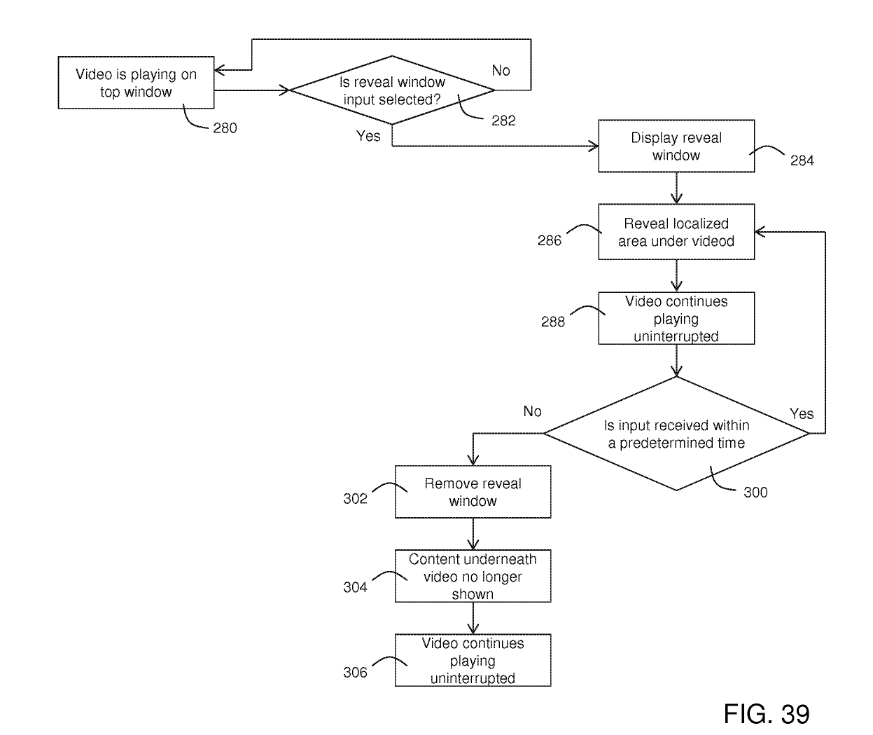

FIG. 39 illustrates computer executable operations performed by the electronic device where an application, such as a multimedia application, is running. At 280, a video is playing and is therefore occupying the top layer of the device's screen. A check is made at 282 to determine if the reveal window input is selected. If not, the video continues playing. If the reveal window input is selected, then a reveal window 38 is displayed at 284. At 286, the reveal window allows for a localized area under the video to be revealed. Even with the reveal window 38 being used, in this example the video continues playing uninterrupted at 288. The user can continue to watch the video, even with content from an application 22 of an underlying layer also visible. A check at 300 is made to determine if input is received in succession within a predetermined time. If the input was not detected, then the reveal window is removed at 302. For example, if the user is first touching the screen but does not provide other input for a predetermined amount of time, then the reveal window may be removed. As such, at 304, content from an underlying application underneath the video is no longer shown and the video can continue playing uninterrupted. If input was received within a predetermined time at 300, then localized content under the video continues to be revealed and the process continues from 286.

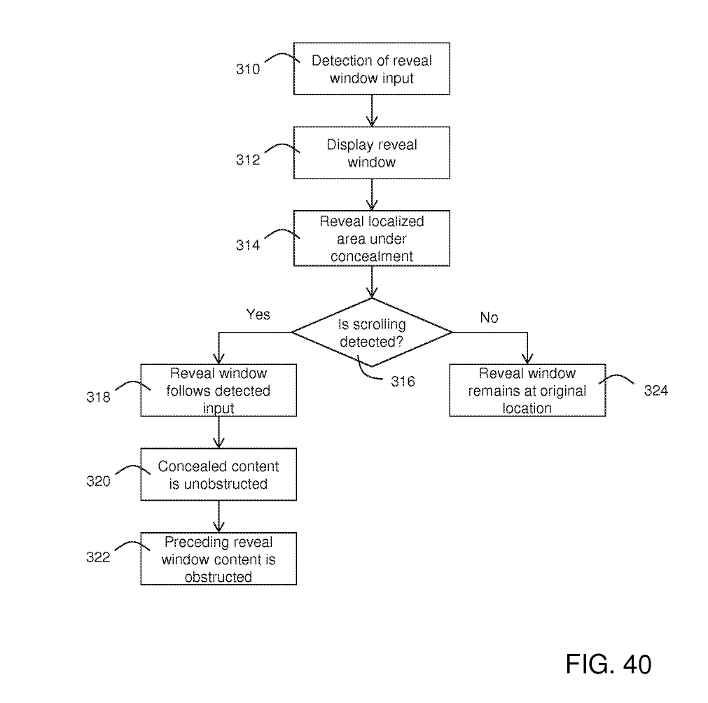

FIG. 40 illustrates the operations that can be performed by the electronic device when scrolling of the reveal window 38 is performed. At 310, an input to initiate a reveal window 38 is detected before the reveal window 38 appears at 312. This causes a localized area previously under concealment to be revealed at 314. A check is made at 316 to determine if scrolling is detected. If no scrolling is detected, the reveal window remains at the original location for as long as the input is detected. For example, if a user is holding a finger over a key on the capacitive keyboard without any movement, then the reveal window 38 does not move. If the appropriate input is not detected, the reveal window 38 can be caused to disappear. If scrolling is detected at 316, the reveal window 38 follows the movements of the input at 318. At 320, content that was previously obstructed is revealed as the reveal window is positioned over the new content. Furthermore, at 322 and due to the movements of the reveal window 38, content that was previously revealed becomes obstructed since the reveal window 38 has transitioned to a new location.

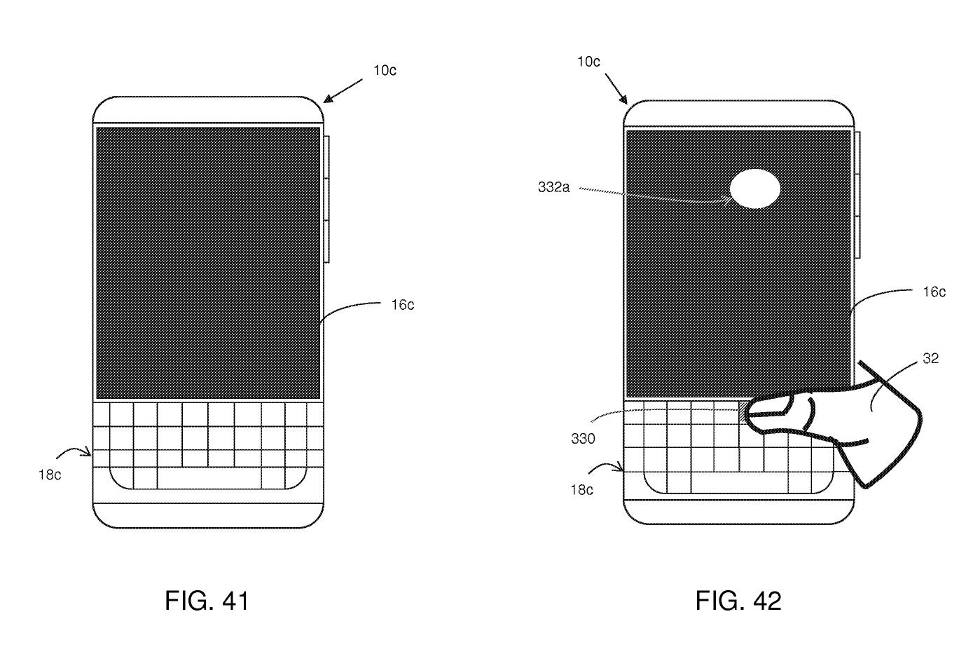

FIGS. 41 to 44 demonstrate the scrolling capabilities of the capacitive keyboard in conjunction with the reveal window. A capacitive keyboard device 10c is shown in FIG. 41 with a display screen 16c and a capacitive keyboard 18c. Turning to FIG. 42, a touch input 32 is detected by the capacitive keyboard 18c. The detected input 330 initiates a reveal window 332a on the display screen 16c. It can be appreciated that the reveal window 332a corresponds with the approximate location of where input is detected on the capacitive keyboard 18c. For example, in FIG. 42 the input 330 is detected in the middle of the top row of the capacitive keyboard 18c. The reveal window 332a is correspondingly located in the middle of the upper quarter of the display screen 16c.

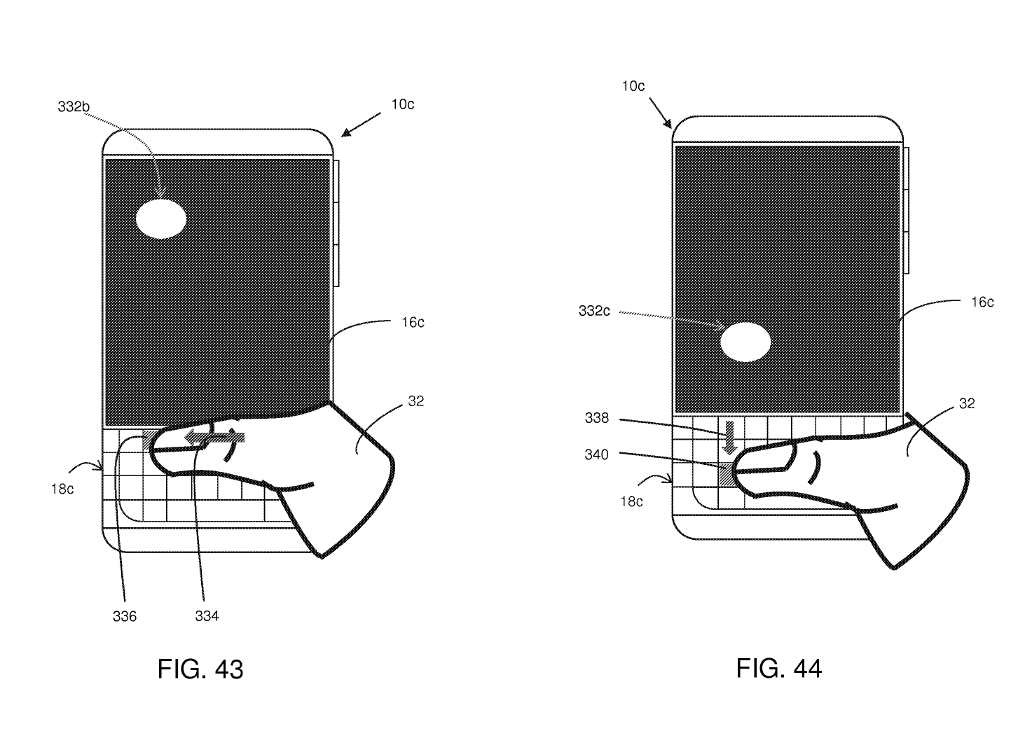

In FIG. 43, the user's hand 32 moves to the left in the direction of the arrow 334. Now, input is detected on a new key 336 on the capacitive keyboard 18c. The reveal window 332b correspondingly moves to the left of the display screen 16c. In FIG. 44, the touch input 32 moves downwards in the direction of the arrow 334. Input is detected on a new key 340 on the capacitive keyboard 18c. The reveal window 332c correspondingly moves downwards on the display screen 16c. It can be appreciated that the reveal window 332 can move anywhere along the two-dimensional display screen 16c, where the movement of the reveal window 332 corresponds to the movement detected on the capacitive keyboard 18c. As such, the capacitive keyboard 18c can be considered as a scaled embodiment of the display screen 16c, where inputs are correspondingly mapped from the former to the latter.

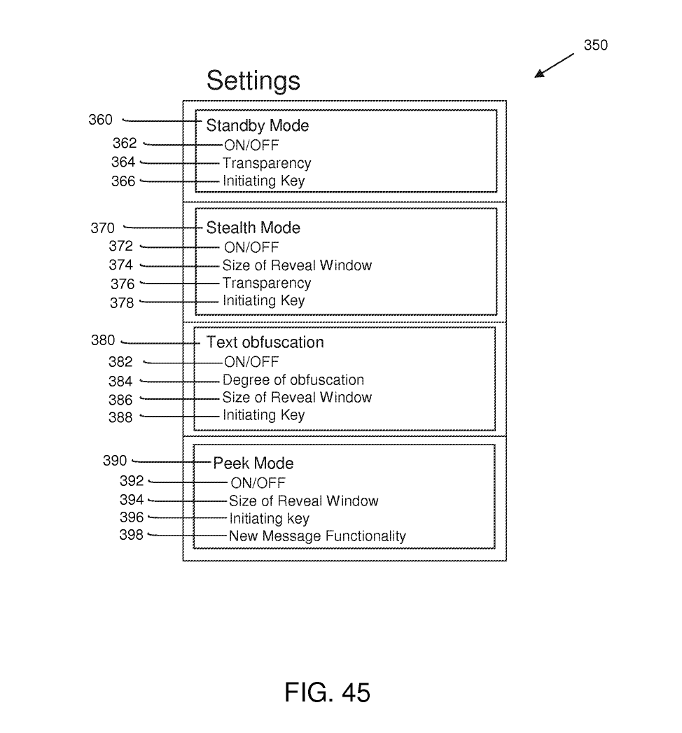

FIG. 45 is an example of a settings page 350 for a mobile device 10. It can be appreciated that the settings page 350 is provided by way of example only. Various different content revealer modes (e.g., standby mode 360, stealth mode 370, text obfuscation 380 and peek mode 390) can all be controlled in the settings page 350. Standby mode 360 includes the option to turn on or off 362 the feature. The transparency 364 of an overlying dimming layer (or brightness of the pixels displaying the application) when standby mode is on can be controlled (e.g. 0 to 100%). The initiating key 366 can also be preset. It can be appreciated that the initiating key 366 can also function as a stop key (i.e. turn off standby mode). Stealth mode 370 includes the option to turn on or off 372 the feature. The size of the reveal window 374 and the transparency 376 can be controlled. The initiating key 378 can also be preset.

Text obfuscation 380 includes the option to turn on or off 382 the feature. The degree of obfuscation 384, or the clarity of the content after an obfuscation layer is used, can be preset. The size of the reveal window 386 and the initiating key 388 can also be controlled. Peek mode 390 includes the option to turn on or off 372 the feature. The size of the reveal window 374 and the initiating key can be preset. The ability to allow new message functionality 398 (e.g. automatically turn peek mode on when a new message is received) can be controlled.

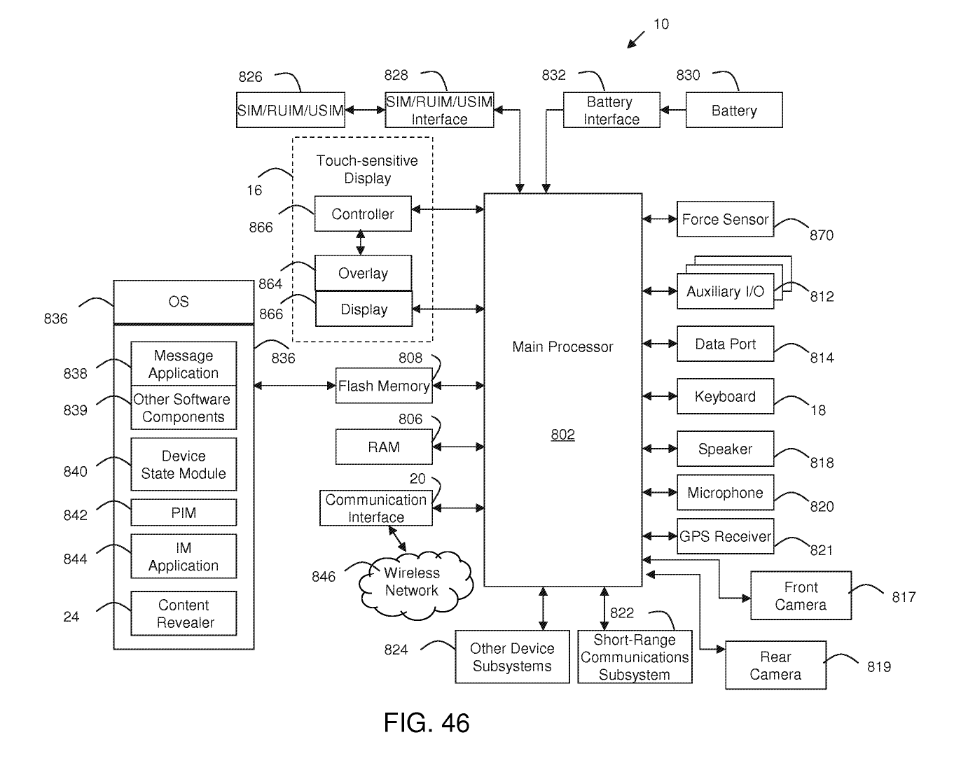

Referring to FIG. 46, to further aid in the understanding of the example mobile devices 10 described above, shown therein is a block diagram of an example configuration of a device configured as a “mobile device”, referred to generally as “mobile device 10”. The mobile device 10 includes a number of components such as a main processor 802 that controls the overall operation of the mobile device 10. Communication functions, including data and voice communications, are performed through at least one communication interface 20. The communication interface 20 receives messages from and sends messages to a wireless network 846. In this example of the mobile device 10, the communication interface 20 is configured in accordance with the Global System for Mobile Communication (GSM) and General Packet Radio Services (GPRS) standards, which is used worldwide. Other communication configurations that are equally applicable are the 3G and 4G networks such as Enhanced Data-rates for Global Evolution (EDGE), Universal Mobile Telecommunications System (UMTS) and High-Speed Downlink Packet Access (HSDPA), Long Term Evolution (LTE), Worldwide Interoperability for Microwave Access (Wi-Max), etc. New standards are still being defined, but it is believed that they will have similarities to the network behavior described herein, and it will also be understood by persons skilled in the art that the examples described herein are intended to use any other suitable standards that are developed in the future. The wireless link connecting the communication interface 20 with the wireless network 846 represents one or more different Radio Frequency (RF) channels, operating according to defined protocols specified for GSM/GPRS communications.

The main processor 802 also interacts with additional subsystems such as a Random Access Memory (RAM) 806, a flash memory 808, a touch-sensitive display 16, an auxiliary input/output (I/O) subsystem 812, a data port 814, a keyboard 18 (physical, virtual, capacitive or combinations thereof), a speaker 818, a microphone 820, a GPS receiver 821, a front camera 817, a rear camera 819, short-range communications subsystem 822, and other device subsystems 824. Some of the subsystems of the mobile device 10 perform communication-related functions, whereas other subsystems may provide “resident” or on-device functions. By way of example, the touch-sensitive display 16 and the keyboard 18 may be used for both communication-related functions, such as entering a text message for transmission over the wireless network 846, and device-resident functions such as a calculator or task list. In one example, the mobile device 10 can include a non-touch-sensitive display in place of, or in addition to the touch-sensitive display 16. For example the touch-sensitive display 16 can be replaced by a display 866 that may not have touch-sensitive capabilities.

The mobile device 10 can send and receive communication signals over the wireless network 846 after required network registration or activation procedures have been completed. Network access is associated with a subscriber or user of the mobile device 10. To identify a subscriber, the mobile device 10 may use a subscriber module component or “smart card” 826, such as a Subscriber Identity Module (SIM), a Removable User Identity Module (RUIM) and a Universal Subscriber Identity Module (USIM). In the example shown, a SIM/RUIM/USIM 826 is to be inserted into a SIM/RUIM/USIM interface 828 in order to communicate with a network.

The mobile device 10 is typically a battery-powered device and includes a battery interface 832 for receiving one or more rechargeable batteries 830. In at least some examples, the battery 830 can be a smart battery with an embedded microprocessor. The battery interface 832 is coupled to a regulator (not shown), which assists the battery 830 in providing power to the mobile device 10. Although current technology makes use of a battery, future technologies such as micro fuel cells may provide the power to the mobile device 10.

The mobile device 10 also includes an operating system 834 and software components 836 to 844 and 24. The operating system 834 and the software components 836 to 844 and 24, that are executed by the main processor 802 are typically stored in a persistent store such as the flash memory 808, which may alternatively be a read-only memory (ROM) or similar storage element (not shown). Those skilled in the art will appreciate that portions of the operating system 836 and the software components 838 to 844 and 24, such as specific device applications, or parts thereof, may be temporarily loaded into a volatile store such as the RAM 806. Other software components can also be included, as is well known to those skilled in the art.

The subset of software applications 836 that control basic device operations, including data and voice communication applications, may be installed on the mobile device 10 during its manufacture. Software applications may include a message application 838, a device state module 840, a Personal Information Manager (PIM) 842, an IM application 844, and content revealer 24. A message application 838 can be any suitable software program that allows a user of the mobile device 10 to send and receive electronic messages, wherein messages are typically stored in the flash memory 808 of the mobile device 10. A device state module 840 provides persistence, i.e. the device state module 840 ensures that important device data is stored in persistent memory, such as the flash memory 808, so that the data is not lost when the mobile device 10 is turned off or loses power. A PIM 842 includes functionality for organizing and managing data items of interest to the user, such as, but not limited to, e-mail, contacts, calendar events, and voice mails, and may interact with the wireless network 846.

Other types of software applications or components 839 can also be installed on the mobile device 10. These software applications 839 can be pre-installed applications (i.e. other than message application 838) or third party applications, which are added after the manufacture of the mobile device 10. Examples of third party applications include games, calculators, utilities, etc.

The additional applications 839 can be loaded onto the mobile device 10 through at least one of the wireless network 846, the auxiliary I/O subsystem 812, the data port 814, the short-range communications subsystem 822, or any other suitable device subsystem 824.

The data port 814 can be any suitable port that enables data communication between the mobile device 10 and another computing device. The data port 814 can be a serial or a parallel port. In some instances, the data port 814 can be a Universal Serial Bus (USB) port that includes data lines for data transfer and a supply line that can provide a charging current to charge the battery 830 of the mobile device 10.

For voice communications, received signals are output to the speaker 818, and signals for transmission are generated by the microphone 820. Although voice or audio signal output is accomplished primarily through the speaker 818, the display 866 can also be used to provide additional information such as the identity of a calling party, duration of a voice call, or other voice call related information.

The touch-sensitive display 16 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. In the presently described example, the touch-sensitive display 16 is a capacitive touch-sensitive display which includes a capacitive touch-sensitive overlay 864. The overlay 864 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

The display 866 of the touch-sensitive display 16 may include a display area in which information may be displayed, and a non-display area extending around the periphery of the display area. Information is not displayed in the non-display area, which is utilized to accommodate, for example, one or more of electronic traces or electrical connections, adhesives or other sealants, and protective coatings, around the edges of the display area.

One or more touches, also known as touch contacts or touch events, may be detected by the touch-sensitive display 16. The processor 802 may determine attributes of the touch, including a location of a touch. Touch location data may include an area of contact or a single point of contact, such as a point at or near a center of the area of contact, known as the centroid. A signal is provided to the controller 866 in response to detection of a touch. A touch may be detected from any suitable object, such as a finger, thumb, appendage, or other items, for example, a stylus, pen, or other pointer, depending on the nature of the touch-sensitive display 860. The location of the touch moves as the detected object moves during a touch. One or both of the controller 866 and the processor 802 may detect a touch by any suitable contact member on the touch-sensitive display 16. Similarly, multiple simultaneous touches, are detected.

In some examples, an optional force sensor 870 or force sensors is disposed in any suitable location, for example, between the touch-sensitive display 16 and a back of the mobile device 10 to detect a force imparted by a touch on the touch-sensitive display 16. The force sensor 870 may be a force-sensitive resistor, strain gauge, piezoelectric or piezoresistive device, pressure sensor, or other suitable device.

It will be appreciated that any module or component exemplified herein that executes instructions may include or otherwise have access to computer readable media (including non-transitory computer readable media) such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of operating an electronic device, the method comprising:
concealing content of a first application user interface;
displaying a reveal window on a portion of the first application user interface, the reveal window providing a view of a portion of the content of the first application user interface; and
enabling the reveal window to be moved to provide additional views of portions of the content of the first application user interface.

2. The method of claim 1, wherein the first application user interface is concealed by a user interface layer overlying the first application user interface.

3. The method of claim 2, wherein the user interface layer corresponds to a second application user interface.

4. The method of claim 2, wherein the user interface layer corresponds to a dimming layer.

5. The method of claim 4, wherein the dimming layer is displayed according to a standby mode.

6. The method of claim 4, wherein the dimming layer is displayed according to a stealth mode.

7. The method of claim 2, wherein the user interface layer corresponds to an obfuscation layer.

8. The method of claim 1, wherein the first application user interface is concealed by darkening pixels of a display screen, and wherein the reveal window is provided using relatively brighter pixels than those being darkened.

9. The method of claim 1, wherein the first application user interface comprises messaging.

10. The method of claim 9, further comprising detecting an input corresponding to at least one of a sliding movement, a scrolling operation, and a reply option.

11. The method of claim 1, wherein the enabling is provided using at least one of a capacitive keyboard, a virtual keyboard, and a tracking portion of a touch-sensitive display.

12. The method of claim 1, wherein an input provided to a capacitive keyboard enables movement of the reveal window while the input is active.

13. The method of claim 1, wherein the enabling is provided by a device being external to the electronic device.

14. An electronic device comprising a processor, a display, at least one input device, and memory, the memory comprising computer executable instructions for:
concealing content of a first application user interface;
displaying a reveal window on a portion of the first application user interface, the reveal window providing a view of a portion of the content of the first application user interface; and
enabling the reveal window to be moved to provide additional views of portions of the content of the first application user interface.

15. A non-transitory computer readable medium comprising computer executable instructions for operating an electronic device, the computer executable instructions comprising instructions for:
concealing content of a first application user interface;
displaying a reveal window on a portion of the first application user interface, the reveal window providing a view of a portion of the content of the first application user interface; and
enabling the reveal window to be moved to provide additional views of portions of the content of the first application user interface.

16. The non-transitory computer readable medium of claim 15, wherein the first application user interface is concealed by a user interface layer overlying the first application user interface.

17. The non-transitory computer readable medium of claim 16, wherein the user interface layer corresponds to a second application user interface.

18. The non-transitory computer readable medium of claim 16, wherein the user interface layer corresponds to a dimming layer.

19. The non-transitory computer readable medium of claim 15, wherein the first application user interface is concealed by darkening pixels of a display screen, and wherein the reveal window is provided using relatively brighter pixels than those being darkened.

20. The non-transitory computer readable medium of claim 15, wherein the first application user interface comprises messaging.
